(19) United States
(12) Patent Application Publication
(10) Pub. No.: US 2024/0422633 A1
(43) Pub. Date: Dec. 19, 2024

(54) METHOD AND DEVICE FOR PERFORMING SELF-OPTIMIZATION AND SELF-CONFIGURATION

(71) Applicant: Samsung Electronics Co., Ltd., Suwon-si, Gyeonggi-do (KR)

(72) Inventors: Xiaoning MA, Beijing (CN); Yu PAN, Beijing (CN); Weiwei WANG, Beijing (CN); Lixiang XU, Beijing (CN); Hong WANG, Beijing (CN)

(21) Appl. No.: 18/701,441

(22) PCT Filed: Oct. 17, 2022
(86) PCT No.: PCT/KR2022/015766

§ 371 Date: Apr. 15, 2024

(30) Foreign Application Priority Data
Oct. 18, 2021 (CN) 202111210757.X

(51) Int. Cl. H04W 36/00; H04W 36/24

(52) U.S. Cl. CPC H04W 36/00833; H04W 36/249

(57) ABSTRACT

The disclosure relates to a method and device for self-optimization and self-configuration, and provides a method performed by a first node in a wireless communication system, including: acquiring, by the first node, first configuration information related to a successful handover report (SHR); transmitting, by the first node, the first configuration information to a user equipment (UE).

### CROSS-REFERENCE TO RELATED APPLICATION(S)

This application is a U.S. National Stage application under 35 U.S.C. § 371 of an International application number PCT/KR2022/015766, filed on Oct. 17, 2022, which is based on and claims priority of a Chinese patent application number 202111210757.X, filed on Oct. 18, 2021, in the Chinese Intellectual Property Office, the disclosure of which is incorporated by reference herein in its entirety.

### TECHNICAL FIELD

The disclosure relates to the field of wireless communication, and more particularly, to a configuration method and device.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

The disclosure is to provide a method and a device for performing self-optimization and self-configuration.

According to an embodiment of the disclosure, there is provided a method performed by a source node in a wireless communication system, including: acquiring, by a source node, first configuration information related to a successful handover report (SHR); transmitting, by the source node, the first configuration information to a UE.

In an implementation, the first configuration information includes at least one of:
a threshold value of the elapsed time of a timer;
information indicating that the user equipment (UE) is required to record the SHR when dual active protocol stack (DAPS) handover is successful but a source cell radio link failure (RLF) occurs;
information indicating that the UE is required to record the SHR when the UE has not performed handover and receives configuration information for legacy handover or the DAPS handover after receiving conditional handover (CHO)-related configuration information;
a CHO-related threshold;
a threshold value of a difference between the time when a radio link problem occurs in the UE after the handover is successful and the time when the handover is successful;
user plane measurements-related information;
a threshold value of a received signal strength indication (RSSI), and/or a threshold value of the duration, and/or an identifier of a bandwidth part (BWP) and/or an identifier of a channel for acquiring the RSSI, of the source cell;
a threshold value of channel occupancy (CO), and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of a listen before talk (LBT) success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of a target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between the time when an NR-U RLF occurs in the UE after the handover is successful and a time when the handover is successful.

In an implementation, the threshold value of the starting time length of the timer includes:
a threshold value of the elapsed time of T310;
a threshold value of the elapsed time of T312;
a threshold value of the elapsed time of T304;
wherein the CHO-related threshold includes a threshold value of a difference between a time when the UE receives CHO configuration information and a time when the UE receives an indication of the legacy handover or the DASP handover, and/or a threshold value of a difference between a time when the UE receives the CHO configuration information and a time when the UE performs the CHO.

In an implementation, the user plane measurements-related information includes at least one of:
information indicating whether the UE performs the user plane measurements;
a list of data radio bearer (DRB) information requiring the user plane measurements;
information indicating whether a service interruption time is based on an average of multiple or all service interruption time in the list of DRB information;
time interval of packets configuration-related information before the handover.

In an implementation, the time interval of packets configuration-related information includes at least one of:
time interval information;
a number of consecutive packets,
wherein the DRB information includes at least one of:
a DRB ID;
a list of QoS flow information included in the DRB,
wherein the QoS flow information includes an QoS flow identifier.

In an implementation, the acquiring of the first configuration information related to the successful handover report (SHR) by the source node includes: generating, by the source node, the first configuration information, or, receiving, by the source node, the first configuration information from a target node.

In an implementation, the acquiring of the first configuration information related to the successful handover report (SHR) by the source node includes: receiving, by the source node, a part or all of the first configuration information from the target node.

The method according to an embodiment of the disclosure further includes: receiving the SHR from a third node; transmitting all or a part of the SHR to a target node.

According to an embodiment of the disclosure, there is provided a method performed by a user equipment (UE), including: receiving, by the UE, first configuration information related to a successful handover report (SHR) from a source node; generating, by the UE, the SHR based on the first configuration information.

In an implementation, the SHR includes at least one of:
information indicating that the UE has not performed handover and receives configuration information for legacy handover or DAPS handover after receiving CHO-related configuration information;
information indicating that a difference between a time when the UE receives CHO configuration-related information and a time when the UE performs the handover in CHO is greater than a threshold value;
information indicating whether the SHR should be analyzed by a source cell or a target cell;
information indicating that T310 is started in a threshold time after the handover is successful, and/or the elapsed time of the timer of T310;
information indicating that T312 is started in a threshold time after the handover is successful, and/or the elapsed time of the timer of T312;
a problem type;
an identifier for a BWP and/or a channel where the problem occurs;
a new radio unlicensed band (NR-U) related measurement report on the BWP and/or the channel where the problem occurs;
NR-U related measurement reports on other BWPs and/or channels;
an energy detection (ED) threshold;
a maximum ED threshold;
an ED threshold offset, indicating an offset from a default value of the maximum ED threshold;
a flag indicating whether there are other access technologies using the same band resources;
a channel access priority;
one or more containers including SHRs in one or more RAT format;
a container including a random access (RA) report;
a container including a radio link failure (RLF) report;
information for associating the RA report and/or the RLF report;
information for indicating that the UE generates the RA report and/or the RLF report in an association relationship;
UE identity;
random access configuration information.

The method according to an embodiment of the disclosure further includes: generating, by the UE, an RA report or an RLF report, wherein the RA report or the RLF report includes at least one of:
a first container including the SHR;
information for associating the RA report or the RLF report with the SHR.

In an implementation, wherein,
A, the SHR is a first SHR that is encoded in a radio access technology (RAT) format of a first cell; or
B, the SHR is a first SHR that is encoded in the RAT format of the first cell, wherein the first SHR includes a first container including a second SHR encoded in an RAT format of a second cell; or
C, the SHR includes a first SHR and a second container, wherein the first SHR is encoded in the RAT format of the first cell, and the second container includes the second SHR encoded in the RAT format of the second cell; or
D, the SHR includes a third container and a second SHR, wherein the third container includes a first SHR encoded in the RAT format of the first cell, and the second SHR is encoded in the RAT format of the second cell; or
E, the SHR includes a fourth container and a fifth container, wherein the fourth container includes a first SHR encoded in the RAT format of the first cell, and the fifth container includes a second SHR encoded in the RAT format of the second cell,
wherein the first cell is one of a cell of the source node or a cell of a target node, and the second cell is the other cell of the source node or the other cell of the target node,
or, the first cell is a cell determined by the UE based on content of the SHR, and the second cell is a cell in a different RAT format from the first cell among cells related to the SHR.

The method according to an embodiment of the disclosure further includes: transmitting the SHR to a third node, wherein:
in a case of A, if an encoding format of the SHR is different from that of the third node, a sixth container and a cell identity of the first cell are transmitted to the third node, and the sixth container includes the SHR;
in a case of B, if an encoding format of the first SHR is different from that of the third node, a seventh container and the cell identity of the first cell are transmitted to the third node, and the seventh container includes the SHR;
in a case of C, if an encoding format of the first SHR is different from that of the third node, an eighth container and the cell identity of the first cell are transmitted to the third node, and the eighth container includes the SHR;
in a case D, if an encoding format of the second SHR is different from that of the third node, a ninth container and the cell identity of the first cell are transmitted to the third node, and the ninth container includes the SHR; and
in a case of E, the fourth container and the cell identity of the first cell, and the fifth container and a cell identity of the second cell are transmitted to the third node.

According to an embodiment of the disclosure, there is provided a method performed by a third node in a wireless communication system, including: receiving, by the third node, a successful handover report (SHR) from a UE; transmitting, by the third node, a part or all of the SHR to a source node or a target node based on the SHR.

In an implementation, the SHR includes a flag indicating a cell for analyzing the SHR, the third node transmits the SHR to a node for analyzing the SHR based on a cell identity indicated by the flag that is included in the SHR based on the flag.

In an implementation, the SHR comprises a container and a cell identity, the third node transmits the container to a node corresponding to the cell identity.

According to an embodiment of the disclosure, there is provided a method performed by a target node in a wireless communication system, including: receiving an SHR from a third node; transmitting all or a part of the SHR to a source node.

According to an embodiment of the disclosure, there is provided a communication device, including:
a transceiver configured to receive and transmit signals;
a memory configured to store information and data;
a processor coupled with the memory and the transceiver, and configured to perform the methods according to the embodiments of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a system architecture diagram of system architecture evolution (SAE);

FIG. 2 is an exemplary system architecture according to an embodiment of the disclosure;

FIG. 3 is a schematic diagram of Embodiment 1;

FIG. 4 is a schematic diagram of Embodiment 2;

FIG. 5 is a schematic diagram of Embodiment 3;

FIG. 6 is a schematic diagram of Embodiment 4;

FIG. 7 is a schematic diagram of Embodiment 5;

FIG. 8 is a schematic diagram of Embodiment 6;

FIG. 9 is a schematic diagram of Embodiment 7; and

FIG. 10 illustrates a schematic block diagram of a device according to an embodiment of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a”, “an”, “said” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

In a 5G system, a user equipment (UE) is a terminal device used to receive data. An access node provides an interface for the UE to access a wireless network. An access control and mobility management function entity (AMF) is responsible for managing mobility context and security information of the UE. A user plane function entity (UPF) mainly provides functions of the user plane. A session management function (SMF) is responsible for session management.

The access node may include a centralized unit (CU) and a distributed unit (DU). The centralized unit may include a centralized unit control plane entity (CU-CP) and a centralized unit user plane entity (CU-UP).

The 5G mobile communication network may be deployed using an NR-unlicensed band (NR-U) as a supplement and extension to a licensed band service.

Because the unlicensed band has a characteristic of sharing without grant, it may contend with other communication technologies such as WLAN and the like that also use such band. In order to achieve fair coexistence with other technologies, a listen before talk (LBT) mechanism is supported, that is, channel occupancy is monitored before communication, and the channel may be used only when a condition is satisfied. When a requested channel is occupied for a long time, a node that needs to communicate cannot transmit data, and LBT failure will occur.

In a mobility scenario, the UE may handover from a cell to another according to an instruction of the network.

The handover may be legacy handover, conditional handover (CHO), or dual active protocol stack handover (DAPS Handover).

Even if the handover finally succeeds sometimes, there will be some problems in the handover process before the handover finally succeeds. For example, when the handover is initiated, a quality of a radio link between the UE and a source cell is already poor, so the radio link between the UE and the source cell is about to fail during the handover.

Considering the present situation of the wireless communication technology, the application at least considers the following problems and proposes some solutions.

Problem 1: the UE may record a successful handover report (SHR) under a certain activation condition. The activation condition may be at least one of:
1. timer T310 has been started, and the elapsed time of the timer exceeds a threshold value;
2. timer T312 has been started, and the elapsed time of the timer exceeds a threshold value;
3. timer T304 has been started, and the elapsed time of the timer exceeds a threshold value;
4. the DAPS handover is successful, but an RLF occurs on the radio link with the source cell (for convenience of expression, the activation condition is referred to as an “activation condition 4” in the following description).

The corresponding threshold values in the activation conditions are configured by the network.

On the other hand, after the handover is successful, if there is a radio link problem within a short time (for the convenience of description, this case is also described as a “recent radio link problem” below), it may be due to an improper selection of a target cell. In this case, it is also necessary to report to the network. The radio link problem may be at least one of:
timer T310 has been started;
timer T312 has been started.

A time length between a time when the handover is successful and a time when the radio link problem occurs is configured by the network.

However, the threshold values or the time lengths involved in the above aspects is decided by which cell, for example, the source cell or the target cell, and related signaling processes, etc., have not yet been determined.

In addition, in a CHO scenario, the existing activation conditions of the SHR cannot reflect the possible problems in the handover process. For example, a handover condition is not fulfilled after UE receiving CHO-related configuration information, and the UE does not perform handover successfully until it receives an instruction to perform the legacy handover or the DAPS handover. This case also needs to be indicated in the SHR accordingly, so that the network may perform corresponding parameter optimization for the CHO.

Problem 2: in different scenarios, such as a scenario where the source cell and the target cell have the same or different RATs, in which RAT format the SHR generated by the UE should be encoded has not been determined.

Problem 3: in different scenarios, such as the scenario where the source cell and the target cell have the same or different RATs, how to report the SHR generated by UE to the network, which cell should read and analyze the content therein and make corresponding optimization, and the related signaling procedure have not been determined.

Problem 4: the UE may generate a random access report (RA report) in a random access process. In a scenario where the handover is successful, the UE may generate both the RA Report and the SHR. The two reports may be transmitted to the wireless network at different time points. If the wireless network may correlate the RA report and the SHR generated for the same handover event, it is beneficial for the wireless network to analyze and find incorrect configuration parameters.

At present, there is no mechanism that may be used to correlate the RA report and the SHR generated for the same handover event.

In addition, the UE may generate both a Radio link failure report (RLF report) and the SHR in the handover procedure, such as the DAPS handover. The two reports may be transmitted to the wireless network at different time points. If the wireless network may correlate the RLF report and the SHR generated for the same handover event, it is beneficial for the wireless network to analyze and find incorrect configuration parameters.

At present, there is no mechanism that may be used to correlate the RLF report and the SHR generated for the same handover event.

Problem 5: how to support the SHR in an NR-U scenario, whether a new activation condition is needed, whether new information needs to be added to the SHR, and the related signaling procedure have not been determined.

The disclosure provides a method and device for self-optimization and self-configuration. By the method, the support and utilization of the SHR by the wireless communication network may be enhanced, so that the configuration of mobility related parameters by the network may be optimized, the network performance may be improved, and the possibility of radio link failure in the handover may be reduced.

The solutions of the disclosure will be illustrated in detail below.

Activation conditions of the SHR of the UE is configured by the network. When at least one activation condition is satisfied and the handover is successful, the UE records the SHR, which includes a cell identity of the source cell and a cell identity of the target cell. When the UE is connected to the target cell or other cells, the UE reports the existence of the SHR to the network, and reports the SHR to the network according to an indication of the network. According to the information in the SHR, the network may analyze the SHR, and decide whether self-optimization and self-configuration are needed, such as optimization of the handover timing, optimization of the target cell selection, optimization of handover-related parameters, etc.

The solutions of the disclosure will be described through the following several example scenarios. It should be understood that the following description is only exemplary, and is not intended to limit the disclosure to the following several example scenarios. Those skilled in the art will understand that the disclosure may also include other scenarios.

### Scenario 1

In the description in scenario 1, a node 1 and a node 2 may be, for example, a source node and a target node for handover.

The node 1 decides at least one of:
T310 timer-related information;
T312 timer-related information;
T304 timer-related information;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

The details of the timer-related information, the CHO-related threshold value and the UP measurements-related information will be described in detail in Embodiment 1.

In addition, while three kinds of timer-related information are listed in the above and the following descriptions, it should be understood that the corresponding information described throughout the disclosure may also include other timer-related information related to handover and/or radio link problems, unless otherwise limited in the context.

At least one of the following information may also be decided by the node 2:
a threshold value of the elapsed time of T310;
a threshold value of the elapsed time of T312;
T304-related information;
a threshold value of a difference between a time when a recent radio link problem occurs in the UE after the handover is successful and a time when the handover is successful;
UP measurements-related information.

Alternatively, the node 2 transmits a message 0 to the node 1, which includes at least one of: T304-related information. The node 1 may decide a threshold value of the elapsed time of T304 according to information included in the message 0 as one of the activation conditions of the SHR. This operation is not necessary.

The node 1 transmits a message 1 to the node 2, which includes at least one of:
T310-related information;
T312-related information;
T304-related information;
information indicating that the threshold value of the elapsed time of T304 is decided by the target node, for example, a flag;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

If the message 1 does not include the T304-related information but includes the T310-related information and/or the T312-related information, or if the message 1 includes the flag indicating that the threshold value of the elapsed time of T304 is decided by the target node, the node 2 may decide the threshold value of the elapsed time of T304 by itself.

The node 2 may generate SHR-related configuration information according to the information included in the message 1 or decision by itself, and the SHR-related configuration information includes at least one of:
a threshold value of the elapsed time of T310, expressed as a percentage;
a threshold value of the elapsed time of T312, expressed as a percentage;
a threshold value of the elapsed time of T304, expressed as a percentage;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

The SHR-related configuration information may be used as an activation condition of the SHR. For example, when timers T310 and/or T312 and/or T304 are started, and the elapsed time of the timer is longer than or equal to the threshold value of the elapsed time of T310 and/or T312 and/or T304, the UE records and saves the SHR. For another example, after the handover is successful, the difference between the time when the recent radio link problem occurs to the UE before the handover is successful and the time when the handover is successful is less than or equal to the corresponding threshold value, and the UE records and saves the SHR. For another example, when the UE has not performed the handover and receives the configuration information for the legacy handover or the DAPS handover after receiving the CHO-related configuration information, the UE records and saves the SHR. For another example, the difference between the time when the UE receives the CHO configuration information and the time when the UE performs the legacy handover or the DAPS handover or the CHO is more than or equal to the CHO-related threshold, the UE records and saves the SHR.

The node 2 transmits a message 2 to the node 1, including the SHR-related configuration information.

The node 1 generates an RRC message according to information in the message 2, the RRC message including the SHR-related configuration information.

The RRC message will be transmitted to the UE, and the UE generates the SHR when the activation condition of the SHR is satisfied and reports it to the network at an appropriate time according to information included in the RRC message.

The SHR may include at least one of:
a cell identity of the source cell;
a cell identity of the target cell;
a measurement result of the source cell;
a measurement result of the target cell;
measurement results of neighboring cells;
measurement results of candidate target cells in the CHO;
a flag indicating that a radio link failure occurs on the source cell during the DAPS handover;
a difference between a time when the UE receives CHO configuration-related information and a time when the UE performs the CHO during the CHO;
location information of the UE;
information indicating that elapsed time of T310 is too long, for example,
a flag;
information indicating that elapsed time of T312 is too long, for example, a flag;
information indicating that elapsed time of T304 is too long, for example,
a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too long, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312.

The details of the cell identity, the starting time being too long, and the UP measurements result-related information will be described in Embodiment 1.

It should be understood that throughout the description of the disclosure, in order to make the description more concise and clear, descriptions such as “too long” and “in a short time” are used, where “too long” means exceeding or equal to a certain threshold, and “in a short time” means being during a time not exceeding a certain threshold.

### Scenario 2

In the description in scenario 2, the node 1 is a node that generates the SHR, such as a user equipment (UE), and the node 2 is a node to which the node 1 is connected, for example, it may be the target node for handover or other access nodes.

The node 1 (e.g., UE) may generate different reports in or after the same handover procedure, such as a report 1 and a report 2.

The handover may be legacy handover, or CHO, or DAPS handover.

The node 1 may have different methods to associate the report 1 with the report 2, for identifying that the report 1 and the report 2 are related to the same handover event.

Method 1: only the report 1 is generated, where the report 1 includes content of the report 2, for example, the report 2 is included in a container of the report 1; or only the report 2 is generated, where the report 2 includes content of the report 1, for example, the report 1 is included in a container of the report 2.

Method 2: both the report 1 and the report 2 are generated, and information for association, such as the same information, or information that is different but may be used to correspond the report 1 to the report 2 is added to the report 1 and the report 2.

The information may be time stamp information; and/or an identification, such as C-RNTI and/or RA-RNTI and/or Preamble; and/or a number, such as a serial number; and/or a flag. The same information may be used to associate the report 1 with the report 2.

Method 3: both the report 1 and the report 2 are generated, and a flag is added to the report 1 to indicate that the node 1 also generates the report 2; or a flag is added to the report 2 to indicate that the node 1 also generates the report 1.

When the node 2 instructs the node 1 to transmit the report 1 to the node 2, the node 2 may judge that the node 1 also generates the report 2 according to the flag, and the node 2 may instruct the node 1 to transmit the report 2 to the node 2. Alternatively, when the node 2 instructs the node 1 to transmit the report 2 to the node 2, the node 2 may judge that the node 1 also generates the report 1 according to the flag, and the node 2 may instruct the node 1 to transmit the report 1 to the node 2.

The node 1 may use one or more of the methods to associate the report 1 with the report 2.

The report 1 may be an SHR, which may be one SHR or a list of SHRs including at least one SHR, and the report 2 may be an RA report and/or an RLF report.

The node 2 or other nodes may analyze and judge the problems in the handover according to the association between the report 1 and the report 2, and optimize handover-related parameters, so as to improve the network performance and reduce the possibility of radio link failure in the handover.

### Scenario 3

The source cell and the target cell for the handover may correspond to the same radio access technology (RAT), for example, both are NR, and the SHR generated by the UE is encoded according to the RAT.

In addition, the source cell and the target cell for the handover may be different RATs, for example, the source cell is RAT A, such as NR, and the target cell may be RAT B, such as LTE.

The UE may generate an SHR encoded in an RAT A format or an SHR encoded in an RAT B format.

In addition, the information included in the SHR is related to the radio link problems that occur in the handover procedure. The UE may also generate SHRs encoded in different formats according to the related radio link problems.

For example, if the elapsed time of T310 is too long, the SHR includes information indicating that the elapsed time of T310 is too long, and optionally, it may also include the measurement result of the source cell and/or the target cell and/or the neighboring cell. The measurement result is measured in the source cell, so that the SHR generated by the UE based on the radio link problem is encoded in an RAT format of the source cell. For example, if the elapsed time of T304 is too long, the SHR includes information indicating that the elapsed time of T304 is too long, and optionally, it may also include a part or all of random access-related configuration information. The random access-related configuration information is generated by the target cell and encoded in an RAT format of the target cell, so that the SHR based on the radio link problem generated by the UE is encoded in the RAT format of the target cell.

If the SHR includes both the radio link problem in the target cell and the radio link problem in the source cell, there are several methods to decide the encoding format:

Method A: the UE generates a list of SHRs. The list includes at least one SHR in the RAT A format, and information indicating which format the SHR is encoded in, for example, a flag; and at least one SHR in the RAT B format, and information indicating which format the SHR is encoded in, for example, a flag. Information included in each SHR is decided by the UE according to different radio link problems involved in the SHR.

Method B: the UE may generate a nested SHR, for example, the UE generates an SHR in the RAT A format, which includes a container for including an SHR in the RAT B format; and vice versa. The UE may choose which format of SHR to generate, for example, according to a cell responsible for analyzing the SHR which is decided by the UE.

### Scenario 4

In the description in scenario 4, the node 1 is a node that generates the SHR, such as the UE, and the node 2 is a node to which the node 1 is connected, for example, it may be the target node for handover or other access nodes.

After the successful handover, the node 1 (e.g., UE) generates the SHR. The node is connected to the node 2, and the node 1 indicates to the node 2 in the message 1 that the node 1 generates the SHR. The node 2 requests the node 1 to transmit the SHR in the message 2, and the node 1 transmits the SHR to the node 2 in a message 3.

The SHR should be forwarded by the node 2 to the cell responsible for analyzing the SHR, and used for the cell to analyze and judge the problems. The cell responsible for analyzing the SHR may be the source cell or the target cell.

With regard to different cases of the cell responsible for analyzing the SHR, there may be several methods as follows:

Method 1: the cell responsible for analyzing the SHR is the source cell for the handover.

If the UE generates an SHR, the SHR may be a nested SHR:
if an RAT format of the SHR is the same as that of the node 2, the node 2 may read the SHR and determine which cell the source cell is by the cell identity of the source cell therein.

If the RAT format of the SHR is different from that of the node 2, the SHR is included in a container in the message 3. The node 1 may add a cell identity outside the container. The cell identity is the cell identity of the source cell.

In this way, the node 2 may judge which cell the source cell is according to the cell identity outside the container or the cell identity of the source cell in the SHR, so that the SHR may be forwarded to the source cell.

If the UE generates a list of SHRs:
then SHRs in a RAT format different from that of the source cell in the list of SHRs are put into a container. The list of SHRs includes at least one SHR in the same RAT format as that of the source cell, and at least one container. The container includes SHRs in a format different from the RAT in the list. Optionally, information indicating which format the SHR, for example, a flag, is encoded in is added outside the container.

If the RAT of the source cell is the same as that of the node 2, the node 2 may read SHRs in the same RAT format as itself in the list, and determine which cell the source cell is by the cell identity of the source cell therein.

If the RAT of the source cell is different from that of the node 2, the list of SHRs may be included in a container. The node 1 may add a cell identity outside the container. The cell identity is the cell identity of the source cell.

In this way, the node 2 may judge which cell the source cell is according to the cell identity outside the container or the cell identity of the source cell in the SHR, so that the SHR may be forwarded to the source cell.

Method 2: a node responsible for analyzing the SHR is the target cell for the handover.

If the UE generates an SHR, the SHR may be a nested SHR:
if the RAT format of the SHR is the same as that of the node 2, the node 2 may read the SHR and determine which cell the target cell is by the cell identity of the target cell therein.

If the RAT format of the SHR is different from that of the node 2, the SHR is included in a container in the message 3. The node 1 may add a cell identity outside the container. The cell identity is the cell identity of the target cell.

In this way, the node 2 may judge which cell the target cell is according to the cell identity outside the container or the cell identity of the target cell in the SHR, so that the SHR may be forwarded to the target cell.

If the UE generates a list of SHRs:
then SHRs in different RAT formats from the target cell in the list of SHRs are put into the container. That is, the list of SHRs may be generally encoded in the RAT format of the target cell, and includes at least one SHR with a format the same as the RAT, and at least one container. The container includes SHRs different from the RAT format in the list. Optionally, information indicating which format the SHR is encoded in is added outside the container, for example, a flag.

If the RAT of the target cell is the same as that of the node 2, the node 2 may read SHRs in the same RAT format as itself in the list of SHRs, and determine which cell the target cell is by the cell identity of the target cell therein.

If the RAT of the target cell is different from that of the node 2, the list of SHRs may be included in a container. The node 1 may add a cell identity outside the container. The cell identity is the cell identity of the target cell.

In this way, the node 2 may judge which cell the target cell is according to the cell identity outside the container or the cell identity of the target cell in the SHR, so that the SHR may be forwarded to the target cell.

Method 3: the node 1 decides the cell according to the information in the SHR.

Different cells should be responsible for analyzing different information in the SHR according to the related radio link problems involved in the SHR, for example, if the SHR includes the problem of random access in the target cell and/or the random access-related configuration information in the target cell, the SHR should be analyzed by the target cell; and if the SHR includes information indicating that the starting time of T310 is too long, the SHR should be analyzed by the source cell. A node 4 may judge which cell should be responsible for analyzing the SHR according to the related radio link problems.

If the UE generates an SHR, the SHR may be a nested SHR:
if the RAT format of the SHR is the same as that of the node 2, the node 1 may add a flag in the SHR to indicate which cell should be responsible for analyzing the SHR. The node 2 may read the SHR, and judge which cell should be responsible for analyzing the SHR by the flag therein, and/or the cell identity of the source cell, and/or the cell identity of the target cell.

If the RAT format of the SHR is different from that of the node 2, the SHR may be included in a container. The node 1 may add a cell identity outside the container. If the node 1 judges that the target cell should be responsible for analyzing the SHR, the cell identity is the cell identity of the target cell; and if the node 1 judges that the source cell should be responsible for analyzing the SHR, the cell identity is the cell identity of the source cell.

In this way, the node 2 may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

If the UE generates a list of SHRs:
if the node 1 judges that the source cell should be responsible for analyzing the SHR, it is processed as described in Method 1.
if the node 1 judges that the target cell should be responsible for analyzing the SHR, it is processed as described in Method 2.
the list of SHRs may also be encoded in the RAT format of the node 2, that is, RATs in different RAT formats from that of the node 2 in the list of SHRs generated by the UE are put into a container, and the resulting list of SHRs includes at least one SHR in the same RAT format as that of the node 2, and at least one container. The container includes SHRs with a different format from the RAT format in the list. Optionally, information indicating which format the SHR is encoded in, for example, a flag, is added outside the container. The node 1 may add a flag in the SHR which is the same as the RAT format to indicate which cell should be responsible for analyzing the SHR.
alternatively, for items of various RAT formats in the list of SHRs generated by the UE, the node 1 may also generate at least two containers. A first container includes at least one SHR in the same format as the source cell, and a cell identity is added outside the container, where the cell identity is the cell identity of the source cell. A second container includes at least one SHR in the same format as the target cell, and a cell identity is added outside the container, where the cell identity is the cell identity of the target cell. The cell identity outside the container may indicate that the node 2 is required to forward the SHR in the container to a cell corresponding to the cell identity for analysis.

In this way, the node 2 may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

If the node where the source cell or the target cell is located consists of a CU and a DU, the CU may transmit an SHR to the DU after receiving the SHR, and the DU may analyze and judge the problems according to content in the SHR and perform optimization. For example, if the SHR includes the problem of random access and/or random access-related configuration information, the DU may judge whether the parameters of random access-related configuration should be optimized according to the information.

### Scenario 5

In the description in scenario 5, the node 1 and the node 2 may be, for example, the source node and the target node for handover.

In a scenario where the node 1 is deployed using an NR-U band, trigger conditions of the SHR and/or information included in the SHR may be different from the above.

The node 1 decides at least one of:
a threshold value of an RSSI, and/or a threshold value of duration, and/or an identifier of a BWP and/or an identifier of a channel for acquiring the RSSI, of the source cell;
a threshold value of channel occupancy (CO), and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate of the source cell, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The above “threshold value of duration” refers to a threshold value of duration for which the corresponding measured value satisfies the corresponding threshold condition of the measured value. For example, for the “threshold value of an RSSI, and/or a threshold value of duration, and/or an identifier of a BWP and/or an identifier of a channel for acquiring the RSSI, of the source cell”, where the “threshold value of duration” refers to duration in which the measured RSSI of the source cell satisfies the condition specified by the threshold value of the RSSI of the source cell (for example, but is not limited to, greater than the threshold value of the RSSI of the source cell), and the “threshold value of duration” in other information items has the similar meaning.

The details of the identifier of the BWP, the identifier of the channel and the NR-U radio link problem are described in Embodiment 1.

At least one of the following information may also be decided by the node 2:
a threshold value of an RSSI, and/or a threshold value of duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The node 1 transmits the message 1 to the node 2, which includes at least one of:
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The node 2 may generate an RRC message according to the information included in the message or decision by itself. The RRC message includes at least one of:
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The information may be used as the activation condition of the SHR. For example, when the UE performs the handover, the NR-U radio link problem occurs in the UE in the source cell, for example, the RSSI measured by the UE in the source cell exceeds or equals to the threshold value of the RSSI of the source cell, and the duration exceeds or equals to the threshold value of the duration, the UE records and saves the SHR; the difference between the time when the NR-U radio link problem occurs in the UE after the UE performs the handover successfully and the time when the handover is successful is less than or equal to the corresponding threshold value, the UE records and saves the SHR.

The RRC message will be transmitted to the UE, and the UE generates the SHR when the activation condition of the SHR is satisfied and reports it to the network at an appropriate time according to information included in the RRC message.

The SHR may include at least one of:
a problem type;
an identifier of a BWP and/or a channel where the problem occurs;
an NR-U related measurement report on the BWP and/or channel;
NR-U related measurement reports on other BWPs and/or channels;
an energy detection (ED) threshold;
a maximum ED threshold;
an ED threshold offset (energyDetectionThresholdOffset, indicating an offset from a default value of the maximum ED threshold);
a flag indicating whether there are other access technologies using the same frequency band resources (absenceOfAnyOtherTechnology);
a channel access priority (channelAccessPriority).

The details of the problem type and the NR-U related measurement reports will be described in Embodiment 1.

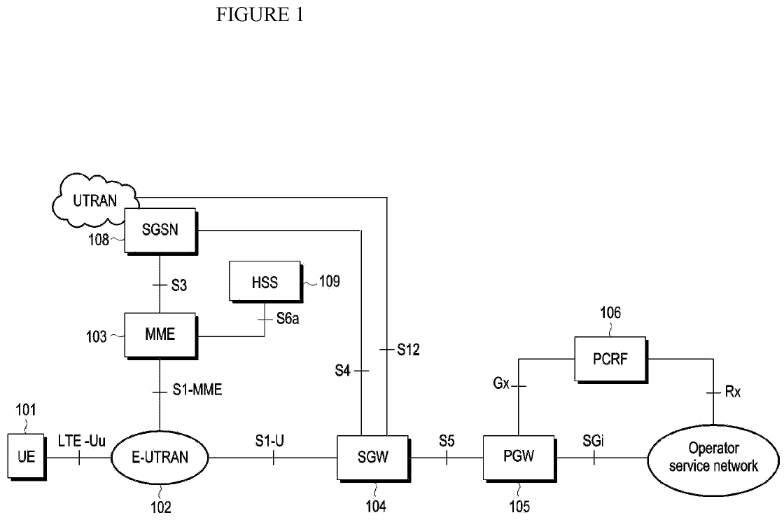

FIGS. 1 to 10 discussed below and various embodiments for describing the principles of the disclosure in this patent document are only for illustration and should not be interpreted as limiting the scope of the disclosure in any way. Those skilled in the art will understand that the principles of the disclosure may be implemented in any suitably arranged system or device.

FIG. 1 is an exemplary system architecture of system architecture evolution (SAE).

Referring to FIG. 1, user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the UE, an address of a serving node, user security information, and packet data context of the UE, etc.

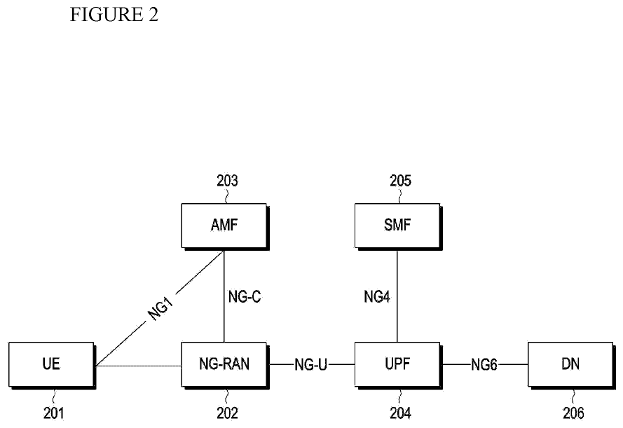

FIG. 2 is an exemplary system architecture according to various embodiments of the disclosure. Other embodiments of the system architecture 200 may be used without departing from the scope of the disclosure.

Referring to FIG. 2, User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

The application provides a self-configuration and self-optimization method. In order to make the purpose, technical solutions and advantages of the application clearer, the application will be further illustrated in detail with reference to the drawings and embodiments. The detailed description of operations unrelated to the application is omitted here.

In the following description, for the sake of simplicity, the descriptions of “node 1”, “node 2”, “node 3” and “node 4” are adopted. It should be understood that such descriptions are only examples of the names of the actual nodes that perform related operations, and they may also be other names, for example, they may be described as “source node”, “target node”, “current connecting node” and “UE”, etc., respectively. In addition, throughout the description of the application, the “source node” may represent a source base station or a source cell, and the “target node” may represent a target base station or a target cell, and so on.

Embodiment 1 describes a situation where the node 4 receives configuration information of an SHR and reports the SHR according to the configuration information after successful handover in a wireless communication system.

The handover may be legacy handover, or CHO, or DAPS handover.

The node 1, the node 2, and/or the node 3 may be access nodes, such as gNB, or eNB, or en-gNB, or ng-eNB. The node 4 may be a UE.

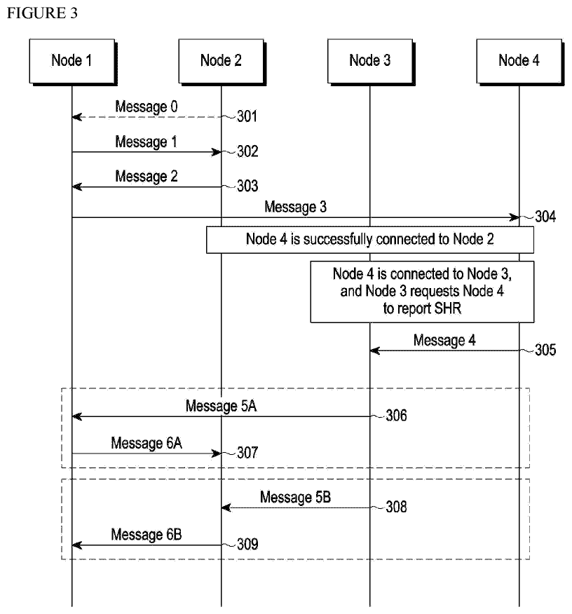

FIG. 3 is a schematic diagram of Embodiment 1, including the following operations:

Operation 301: the node 2 transmits a message 0 to the node 1, which includes at least one of:

T304-related information.

The T304-related information includes a value for timer T304 and/or a threshold value of the elapsed time of T304.

The message may be transmitted using an Xn interface or an X2 interface.

When the Xn interface is used, a message 1 may include, but is not limited to, at least one of: XN SETUP REQUEST, XN SETUP RESPONSE, NG-RAN NODE CONFIGURATION UPDATE, NG-RAN NODE CONFIGURATION UPDATE ACKNOWLEDGE, RESET REQUEST, RESET RESPONSE, and a newly defined Xn message.

When an inter-node interface is the X2 interface, a message of the inter-node interface includes, but is not limited to, at least one of: X2 SETUP REQUEST, X2 SETUP RESPONSE, RESET REQUEST, RESET RESPONSE, ENB CONFIGURATION UPDATE, ENB CONFIGURATION UPDATE ACKNOWLEDGE, and a newly defined X2 message.

The node 1 may decide the threshold value of the elapsed time of T304 according to the information included in the message as one of activation conditions of the SHR.

This operation is not mandatory.

Operation 302: the node 1 transmits the message 1 to the node 2, which includes at least one of:
T310-related information;
T312-related information;
T304-related information;
information indicating that the threshold value of the elapsed time of T304 is decided by the target node, for example, a flag;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or
an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The T310/T312/T304-related information includes the value of timer T310/T312/T304 and/or the threshold value of the elapsed time of T310/T312/T304.

The CHO-related threshold may be a threshold value of a difference between a time when the UE receives CHO configuration information and a time when the UE receives an instruction of the legacy handover or the DASP handover, and/or a threshold value of a difference between the time when the UE receives the CHO configuration information and a time when the UE performs the CHO.

The UP measurements reflect service interruption time of the UE before and after the handover.

The service interruption time may be a difference between: a time when the last packet is received by a DRB or QoS flow of the UE in the source cell, and a time when the first packet is received by the same or corresponding DRB or the same QoS flow as the UE in the target cell.

The UP measurements-related information includes at least one of:
information indicating whether the UE performs the UP measurements, for example, a flag;
a list of DRB information requiring the UP measurements, including at least one DRB information;
information indicating whether the service interruption time is based on an average of multiple or all service interruption time in the list of DRB information, for example, a flag;
time interval of packets configuration-related information before the handover.

The time interval of packets configuration-related information includes at least one of:
time interval information;
the number of consecutive packets.

According to the time interval of packets configuration-related information, time interval of packets may be calculated, such as an average of spacing time between received packets in a specified time interval or an average of spacing time between packets corresponding to a specified number of consecutive packets.

The DRB information includes at least one of:
a DRB ID;
a list of QoS flow information included in the DRB.

The QoS flow information includes an identifier of QoS flow.

The identifier of the BWP includes an ID of the BWP.

The identifier of the channel includes an ID of the channel.

The NR-U radio link problem includes at least one of:
a measured RSSI exceeding the threshold value of the RSSI, and duration exceeding the threshold value of the duration;
a measured CO exceeding the threshold value of the CO, and duration exceeding the threshold value of the duration;
a measured channel availability exceeding the threshold value of the channel availability, and duration exceeding the threshold value of the duration;
a measured LBT success rate exceeding the threshold value of the LBT success rate, and duration exceeding the threshold value of the duration;
a measured LBT failure rate exceeding the threshold value of the LBT failure rate, and duration exceeding the threshold value of the duration.

The message may be transmitted using an Xn interface or an X2 interface.

When the Xn interface is used, a message 1 may include, but is not limited to, at least one of: XN SETUP REQUEST, XN SETUP RESPONSE, NG-RAN NODE CONFIGURATION UPDATE, NG-RAN NODE CONFIGURATION UPDATE ACKNOWLEDGE, RESET REQUEST, RESET RESPONSE, HANDOVER REQUEST, and a newly defined Xn message.

When an inter-node interface is the X2 interface, a message of the inter-node interface includes, but is not limited to, at least one of: X2 SETUP REQUEST, X2 SETUP RESPONSE, RESET REQUEST, RESET RESPONSE, ENB CONFIGURATION UPDATE, ENB CONFIGURATION UPDATE ACKNOWLEDGE, HANDOVER REQUEST, and a newly defined X2 message.

If the message 1 does not include the T304-related information but includes the T310-related information and/or the T312-related information, or if the message 1 includes the flag indicating that the threshold value of the elapsed time of T304 is decided by the target node, the node 2 may decide the threshold value of the elapsed time of T304 by itself.

The node 2 may decide the activation conditions of the SHR according to the information included in the message. For example, deciding the threshold value of the elapsed time of T310, and/or the threshold value of the elapsed time of T312, and/or the threshold value of the elapsed time of T304, and/or the CHO-related threshold, and/or the threshold value of the difference between the time when the recent radio link problem occurs in the UE and the time when the handover is successful. Whether to start the UP measurements and related configuration parameters may further be decided.

Operation 303: the node 2 may refer to the information included in the message or decide the information by itself, thereby generating a message 2. The message 2 includes at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The information may also be included in an RRC container in the message 2.

The message may be transmitted using an Xn interface or an X2 interface.

When the Xn interface is used, the message may include, but is not limited to, at least one of: HANDOVER REQUEST ACKNOWLEDGE, and a newly defined Xn message.

When an inter-node interface is the X2 interface, the message includes, but is not limited to, at least one of: HANDOVER REQUEST ACKNOWLEDGE, and a newly defined X2 message.

Operation 304: the node 1 generates a message 3 according to the information received in the previous operation. The message includes handover-related configuration information, and at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or
an identifier of a BWP and/or an identifier of a channel for acquiring the RSSI, of the source cell;
a threshold value of CO, and/or the threshold value of the duration, and/or
an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The message 3 may be an NR RRC message or an LTE RRC message.

If it is the NR RRC message, the message 3 may include, but is not limited to, at least one of: RRCReconfiguration, HandoverCommand, MobilityFromNRCommand, and a newly defined NR RRC message.

If it is the LTE RRC message, the message 3 may include, but is not limited to, at least one of: RRCConnectionReconfiguration, HandoverCommand, Mobility FromEUTRACommand, and a newly defined LTE RRC message.

The information may be used as the activation condition of the SHR. For example, if the message includes the threshold value of the elapsed time of T310, when timer T310 is started and the elapsed time is longer than the threshold value of the elapsed time of T310, the UE records and saves the SHR; and if the message includes the threshold value of the difference between the time when the recent radio link problem occurs in the UE and the time when the handover is successful, when the difference between the time when the recent radio link problem occurs in the UE and the time when the handover is successful is less than the corresponding threshold value, the UE records and saves the SHR. The processing of the remaining threshold values is similar to this. For another example, if the message includes the flag indicating that the UE is required to record the SHR when the activation condition 4 is satisfied, in the DAPS handover process, if the activation condition 4 is satisfied, the UE records and saves the SHR. For another example, the message includes the UP measurements-related information, and the UE may record UP measurements results. For another example, when the UE performs the handover, the NR-U radio link problem occurs in the UE in the source cell, for example, the RSSI measured by the UE in the source cell exceeds the threshold value of the RSSI of the source cell, and the duration exceeds the threshold value of the duration, the UE records and saves the SHR; and the difference between the time when the NR-U radio link problem occurs in the UE after the UE performs the handover successfully and the time when the handover is successful is less than, or less than or equal to, or equal to the corresponding threshold value, the UE records and saves the SHR.

The node 1 transmits the message 3 to the node 4.

The node 4 performs the handover and successfully connects to the node 2. The node 4 records and saves the SHR according to the information in the message 3.

The SHR may include at least one of:
a cell identity of the source cell;
a cell identity of the target cell;
a measurement result of the source cell;
a measurement result of the target cell;
a measurement result of a neighboring cell;
a measurement result of a candidate target cell in the CHO;
a flag indicating that a radio link failure occurs on the source cell in the DAPS handover;
a difference between a time when the UE receives CHO configuration-related information and a time when the UE performs the CHO in the CHO;
location information of the UE;
information indicating that elapsed time of T310 is too long, for example,
a flag;
information indicating that elapsed time of T312 is too long, for example, a flag;
information indicating that elapsed time of T304 is too long, for example,
a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too large, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312;
a problem type;
an identifier of a BWP and/or a channel where the problem occurs;
an NR-U related measurement report on a BWP and/or a channel where the problem occurs;
NR-U related measurement reports on other BWPs and/or channels;
an ED threshold;
a maximum ED threshold;
an ED threshold offset (energyDetectionThresholdOffset, indicating an offset from a default value of the maximum ED threshold);
a flag indicating whether there are other access technologies using the same band resources (absenceOfAnyOtherTechnology);
a channel access priority (channelAccessPriority);
a container, including SHRs in different RAT formats;
a container, including an RA report;
a container, including an RLF report;
information for associating the RA report and/or the RLF report, such as time stamp information, and/or an identification (such as C-RNTI and/or RA-RNTI and/or Preamble), and/or a number (such as serial number), and/or a flag;
information for indicating that the UE generates the RA report and/or the RLF report in an association relationship, for example, a flag;
an identity of the UE, such as C-RNTI;
random access configuration information.

The cell identity may be at least one of:
a cell global identity (CGI);
a physical cell ID and absolute radio frequency channel number (ARFCN).

The starting time being too long means that the corresponding timer is started, and a ratio of the starting time length to a value of timeout of the corresponding timer is greater than or equal to a threshold value of the elapsed time of the timer of the corresponding timer. The difference between the time when the UE receives the CHO configuration-related information and the time when the UE performs the handover in the CHO is too large which means that the difference between the time when the UE receives the CHO configuration-related information and the time when the UE performs the handover is greater than or equal to the CHO-related threshold, and the handover may be legacy handover, DAPS handover, or CHO. The starting of T310 and/or T312 in a short time after the handover is successful means that a difference between a time when T310 and/or T312 are started and a time when the handover is successful is less than or equal to the threshold value of the difference between the time when the recent radio link problem occurs in the UE and the time when the handover is successful.

The UP measurements result-related information includes at least one of:
service interruption time;
a list of DRB information in the source cell corresponding to the service interruption time;
a list of DRB information in the target cell corresponding to the service interruption time;
time interval of packets before the handover;
information indicating that the service interruption time is greater than or equal to the time interval of packets before the handover, for example, a flag;
a ratio of the service interruption time to the time interval of packets before the handover.

The list of DRB information includes one or more DRB information. The DRB information includes at least one of:
a DRB ID;
a list of QOS flow information included in the DRB.

The list of QoS flow information includes a PDU Session ID, and/or one or more pieces of QoS flow information.

The QoS flow information includes at least one of:
a QoS flow ID;
5QI.

The problem type may be at least one of:
an NR-U radio link problem occurs in the UE in the source cell, and the NR-U radio link problem;
an NR-U radio link problem occurs in the UE in the target cell in a short time after the handover is successful, and the NR-U radio link problem.

The NR-U related measurement report includes at least one of:
an identifier of a BWP and/or a channel where the measurement occurs;
a received signal strength indicator (RSSI);
channel occupancy (CO);
channel availability;
a number of LBT failures;
a LBT success rate or failure rate;
average transmission time length after the LBT is successful;
transmit power;
maximum transmit power.
a flag indicating whether to enable uplink and downlink COT sharing;
the number of slots for the uplink and downlink COT sharing;
positions of the slots for the uplink and downlink COT sharing;
an ED threshold for the uplink and downlink COT sharing;
a channel access priority for the uplink and downlink COT sharing;
the number of consecutive LBT failures;
a detection time length for detecting the consecutive LBT failures;
a maximum number of times for detecting the consecutive LBT failures;
a ratio of available or unavailable physical resources to all physical
resources;
a channel access priority.

The unavailable physical resources include at least one of:
physical resources occupied by other nodes;
physical resources occupied by the current node;
a sum of the above two.

The available physical resources include at least one of:
physical resources not occupied by other nodes and not occupied by the current node;
physical resources not occupied by other nodes but already occupied by the current node;
a sum of the above two.

All physical resources include at least one of:
all physical resources not occupied by other nodes;
all physical resources already occupied by other nodes;
a sum of the above two.

The CO may be one or more of:
CO representing occupation of the channel by an adjacent node;
CO representing occupation of the channel by the current node;
CO representing a sum of occupation of the channel by the adjacent node and the current node.

The CO may be a ratio of a number of sampled values of the RSSI exceeding or equal to a predetermined threshold to a total number of sampled values, or a time duration with the RSSI exceeding or equal to a predetermined threshold in unit time or a ratio of the time duration to the unit time.

The channel availability is a numerical value representing that the channel is not occupied by any node, which may be a ratio of a number of sampled values obtained by sampling the RSSI lower than or equal to a predetermined threshold to a total number of sampled values, or a time duration with the RSSI lower than or equal to a predetermined threshold in unit time or a ratio of the time duration to the unit time.

The random access configuration information includes a part or all of random access-related configuration information configured by the target cell.

The information included in the SHR is related to the radio link problems that occur in the handover process. The UE may also generate SHRs encoded in different formats according to the related radio link problems.

For example, if the radio link problem is related to the source cell, for example, if the elapsed time of T310 is too long, the SHR includes information indicating that the elapsed time of T310 is too long, and optionally, it may also include the measurement results of the source cell and/or the target cell and/or a neighboring cell, and/or the cell identity of the source cell, and/or the cell identity of the target cell. The measurement result is measured when the UE is connected to the source cell, and the SHR generated by the UE is encoded in the RAT format of the source cell.

For another example, if the radio link problem is related to the target cell, for example, if the elapsed time of T304 is too long, the SHR includes information indicating that the elapsed time of T304 is too long, and optionally, a part or all of the random access-related configuration information, and/or the cell identity of the source cell, and/or the cell identity of the target cell. The random access-related configuration information is generated by the target cell and encoded in the RAT format of the target cell, and the SHR generated by the UE is encoded in the RAT format of the target cell.

If the RATs of the source cell and the target cell are the same, the UE generates an SHR, which is encoded in one RAT format, i.e., said RAT.

If the RATs of the source cell and the target cell are different, and if the radio link problem occurring in the handover process is only related to the source cell, the UE generates an SHR, which is encoded in one RAT format, i.e., the RAT of the source cell; and if the radio link problem occurring in the handover process is only related to the target cell, the UE generates an SHR, which is encoded in one RAT format, i.e., the RAT of the target cell.

If the RATs of the source cell and the target cell are different, for example, the source cell is RAT A, such as NR, and the target cell is RAT B, such as LTE, and both the radio link problem related to the source cell and the radio link problem related to the target cell occur in the handover process, there are different methods to decide the encoding format of the SHR:

Method A: the UE generates a list of SHRs. The list includes at least one SHR in the RAT A format, and optionally, information indicating which format the SHR is encoded in, for example, a flag; and at least one SHR in the RAT B format, and optionally, information indicating which format the SHR is encoded in, for example, a flag.

Method B: the UE generates a nested SHR, for example, the UE generates an SHR in the RAT A format, which includes a container for including an SHR in the RAT B format; and vice versa. The UE may choose which format of the SHR to generate, for example, according to the RAT of a cell responsible for analyzing the SHR decided by the UE.

The node 4 is connected to the node 3, for example, the node 4 is connected to the node 3 which is different from the node 2 for the reason of mobility, or the node 3 and the node 2 is the same node. Therefore, node 3 and the node 2 may be the same node or different nodes. The node 3 may require the node 4 to report the SHR according to the existing mechanism.

Operation 305: the node 4 transmits a message 4 to the node 3. The message includes the SHR.

The message 4 may be an NR RRC message or an LTE RRC message.

The SHR should be forwarded by the node 3 to the cell responsible for analyzing the SHR, for the node to analyze and judge the problem. There are different methods to decide which cell the cell responsible for analyzing the SHR is.

Method 1: the cell responsible for analyzing the SHR is the source cell of the handover (handover related to the SHR).

If the UE generates an SHR, the SHR may be a nested SHR:
if the RAT format of the SHR is the same as that of the node 3, the node 3 may read the SHR and determine which cell the source cell is by the cell identity of the source cell therein.

If the RAT format of the SHR is different from that of the node 3, the SHR is included in a container in the message 3. The node 4 may add a cell identity outside the container. The cell identity is the cell identity of the source cell.

In this way, the node 3 may judge which cell the source cell is according to the cell identity outside the container or the cell identity of the source cell in the SHR, so that the SHR may be forwarded to the source cell.

If the UE generates a list of SHRs:
the list of SHRs may be encoded in the RAT format of the source cell, including at least one SHR in a format which is the same as the RAT format, and at least one container. The container includes SHRs in a format different from the RAT format in the list. Optionally, information indicating which format the SHR is encoded in is added outside the container, for example, a flag.

If the RAT of the source cell is the same as that of the node 3, the node 3 may read SHRs in the same RAT format as itself in the list, and determine which cell the source cell is by the cell identity of the source cell therein.

If the RAT of the source cell is different from that of the node 3, the list of SHRs may be included in a container. The node 4 may add a cell identity outside the container. The cell identity is the cell identity of the source cell.

In this way, the node 3 may judge which cell the source cell is according to the cell identity outside the container or the cell identity of the source cell in the SHR, so that the SHR may be forwarded to the source cell.

Method 2: the node responsible for analyzing the SHR is the target cell of the handover.

If the UE generates an SHR, the SHR may be a nested SHR:
if the RAT format of the SHR is the same as that of the node 3, the node 3 may read the SHR and determine which cell the target cell is by the cell identity of the target cell therein.

If the RAT format of the SHR is different from that of the node 3, the SHR is included in a container in message 3. The node 4 may add a cell identity outside the container. The cell identity is the cell identity of the target cell.

In this way, the node 3 may judge which cell the target cell is according to the cell identity outside the container or the cell identity of the target cell in the SHR, so that the SHR may be forwarded to the target cell.

If the UE generates a list of SHRs:
the list of SHRs may be encoded in the RAT format of the target cell, including at least one SHR in a format which is the same as the RAT format, and at least one container. The container includes SHRs in formats different from the RAT format in the list. Optionally, information indicating which format the SHR is encoded in is added outside the container, for example, a flag.

If the RAT of the target cell is the same as that of the node 3, the node 3 may read SHRs in the same RAT format as itself in the list, and determine which cell the target cell is by the cell identity of the target cell therein.

If the RAT of the target cell is different from that of the node 3, the list of SHRs may be included in a container. The node 4 may add a cell identity outside the container. The cell identity is the cell identity of the target cell.

In this way, the node 3 may judge which cell the target cell is according to the cell identity outside the container or the cell identity of the target cell in the SHR, so that the SHR may be forwarded to the target cell.

Method 3: the node 4 decides the cell responsible for analyzing the SHR according to the information in the SHR.

Different cells should be responsible for analyzing different information in the SHR according to the related radio link problems, for example, if the SHR includes the problem of random access in the target cell and/or the random access-related configuration information in the target cell, the SHR should be analyzed by the target cell; and if the SHR includes information indicating that the starting time of T310 is too long, the SHR should be analyzed by the source cell. The node 4 may judge which cell should be responsible for analyzing the SHR according to the related radio link problems.

If the UE generates an SHR, the SHR may be a nested SHR:
if the RAT format of the SHR is the same as that of the node 3, the node 4 may add a flag in the SHR to indicate which cell should be responsible for analyzing the SHR. The node 3 may read the SHR, and judge which cell should be responsible for analyzing the SHR by the flag therein, and/or the cell identity of the source cell, and/or the cell identity of the target cell.

If the RAT format of the SHR is different from that of the node 3, the SHR may be included in a container. The node 4 may add a cell identity outside the container. If the node 4 judges that the target cell should be responsible for analyzing the SHR, the cell identity is the cell identity of the target cell; and if the node 4 judges that the source cell should be responsible for analyzing the SHR, the cell identity is the cell identity of the source cell.

In this way, the node 3 may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

If the UE generates a list of SHRs:
if the node 4 judges that the source cell should be responsible for analyzing the SHR, it is processed as described in Method 1.
if the node 4 judges that the target cell should be responsible for analyzing the SHR, it is processed as described in Method 2.
the list of SHRs may also be encoded in an RAT format of the node 3, including at least one SHR in a format which is the same as the RAT format, and at least one container. The container includes SHRs in formats different from the RAT format in the list. Optionally, information indicating which format the SHR is encoded in is added outside the container, for example, a flag. The node 4 may add a flag in the SHR in a format which is the same as the RAT format to indicate which cell should be responsible for analyzing the SHR.

The node 4 may also generate at least two containers. A first container includes at least one SHR in the same format as the source cell, and a cell identity is added outside the container, where the cell identity is the cell identity of the source cell. A second container includes at least one SHR in the same format as the target cell, and a cell identity is added outside the container, where the cell identity is the cell identity of the target cell.

In this way, the node 3 may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

Operation 306: it corresponds to the situation where the cell responsible for analyzing the SHR is the source cell in Method 1 or Method 3.

The node 3 transmits a message 5A to the node 1, which includes SHR information.

The SHR information may be an SHR or a list of SHRs.

The message may be transmitted using an Xn interface or an X2 interface.

When the Xn interface is used, the message may include, but is not limited to, at least one of: ACCESS AND MOBILITY INDICATION, HANDOVER REPORT, and a newly defined Xn message.

When an inter-node interface is the X2 interface, the message includes, but is not limited to, at least one of: HANDOVER REPORT, and a newly defined X2 message.

If the SHR information includes an SHR:

The source cell may analyze and judge the problem according to content of the SHR, and perform optimization.

If the source cell judges that some information included in the SHR should be analyzed by the target cell, the source cell may know which cell the target cell is according to the information in the SHR. The source cell may pick a part or all of the information in the SHR and transmit it to the target cell.

If the SHR information includes a list of SHRs:

The source cell may analyze and judge the problem according to content of SHRs in the same RAT format as the source cell in the list of SHRs, and perform optimization.

The source cell may transmit content in the container to the target cell according to the target cell information in the SHR or the cell identity outside the container in the list of SHRs (the target cell in this embodiment).

For example, the source cell may judge that the reason why the UE has been configured with the CHO-related configuration information but does not perform the CHO handover may be improper configuring of parameters in the CHO-related configuration information, according to the information indicating that the UE has not performed the CHO handover and receives configuration information for the legacy handover or the DAPS handover after receiving the CHO-related configuration information and/or the information indicating that a difference between the time when the UE receives the CHO configuration-related information and a time when the UE performs the handover during the CHO procedure is too large in the SHR, and the source cell may optimize the parameters.

For another example, the source cell may judge that, although this handover is successful, it needs to be optimized due to long service interruption time, according to the UP measurements result-related information in the SHR, such as the service interruption time, and/or the list of DRB information in the corresponding source cell, and/or the time interval of packets before the handover.

For another example, the source cell may judge that NR-U related parameters may be improperly configured according to the problem type, and/or the identifier of a BWP and/or a channel where the problem occurs, and/or the NR-U related measurement report on a BWP and/or a channel where the problem occurs, and/or the NR-U related measurement reports on other BWPs and/or channels in the SHR, and the source cell may optimize the parameters.

Operation 307: the node 1 transmits a message 6A to the node 2, which includes a part or all of the information in the SHR, and/or the container in the list of SHRs.

The message may be transmitted using an Xn interface or an X2 interface.

When the Xn interface is used, the message may include, but is not limited to, at least one of: ACCESS AND MOBILITY INDICATION, HANDOVER REPORT, and a newly defined Xn message.

When an inter-node interface is the X2 interface, the message includes, but is not limited to, at least one of: HANDOVER REPORT, and a newly defined X2 message.

The target cell may analyze and judge the problem according to the information or information in the container, and perform optimization

For example, the target cell may judge that random access-related parameters may be improperly configured according to the information indicating that the elapsed time of T304 is too long in the SHR, and the target cell may optimize the parameters.

For another example, the source cell may judge that, although the handover is successful, it needs to be optimized (for example, selecting a more suitable DRB) due to long service interruption time, according to the UP measurements result-related information in the SHR, such as the service interruption time, and/or the list of DRB information of the corresponding target cell, and/or the time interval of packets before the handover.

For another example, the target cell may judge that NR-U related parameters may be improperly configured according to the problem type, and/or the identifier of a BWP and/or a channel where the problem occurs, and/or the NR-U related measurement report on a BWP and/or a channel where the problem occurs, and/or the NR-U related measurement reports on other BWPs and/or channels in the SHR, and the source cell may optimize the parameters.

Operation 308: it corresponds to the scenario where the cell responsible for analyzing the SHR is the target cell in Method 1 or Method 3.

The node 3 transmits a message 5B to the node 2, which includes SHR information.

The SHR information may be an SHR or a list of SHRs.

The message may be transmitted using an Xn interface or an X2 interface.

When the Xn interface is used, the message may include, but is not limited to, at least one of: ACCESS AND MOBILITY INDICATION, HANDOVER REPORT, and a newly defined Xn message.

When an inter-node interface is the X2 interface, the message includes, but is not limited to, at least one of: HANDOVER REPORT, and a newly defined X2 message.

If the SHR information include an SHR:
the target cell may analyze and judge the problem according to content of the SHR, and perform optimization.

If the target cell judges that some information included in the SHR should be analyzed by the source cell, the target cell may know which cell the source cell is according to the information in the SHR. The target cell may pick a part or all of the information in the SHR and transmit it to the source cell.

If the SHR information includes a list of SHRs:
the target cell may analyze and judge the problem according to content of SHRs in the same RAT format as the target cell in the list of SHRs, and perform optimization.

The target cell may transmit content in the container to the source cell according to the source cell of the information in the SHR or the cell identity outside the container in the list of SHRs (the source cell in this embodiment).

Operation 309: the node 2 transmits a message 6B to the node 1, which includes a part or all of the information in the SHR, and/or the container in the list of SHRs.

The message may be transmitted using an Xn interface or an X2 interface.

When the Xn interface is used, the message may include, but is not limited to, at least one of: ACCESS AND MOBILITY INDICATION, HANDOVER REPORT, and a newly defined Xn message.

When an inter-node interface is the X2 interface, the message includes, but is not limited to, at least one of: HANDOVER REPORT, and a newly defined X2 message.

The source cell may analyze and judge the problem according to the information or information in the container, and perform optimization.

Through the above operations, the network may analyze the SHR, and judge whether self-optimization and self-configuration are needed according to the information in the SHR, such as optimization of the handover timing, optimization of selection of the target cell, optimization of handover-related parameters, so that the network performance and user experience are improved.

Embodiment 2 describes a situation where the UE receives configuration information of an SHR and reports the SHR according to the configuration information after successful handover in a 5G system.

The handover is Xn interface-based handover, which may be legacy handover, CHO or DAPS handover.

A source gNB is a gNB where the source cell is located, and a target gNB is a gNB where the target cell is located. A new NG-RAN node may be either a gNB or an ng-eNB.

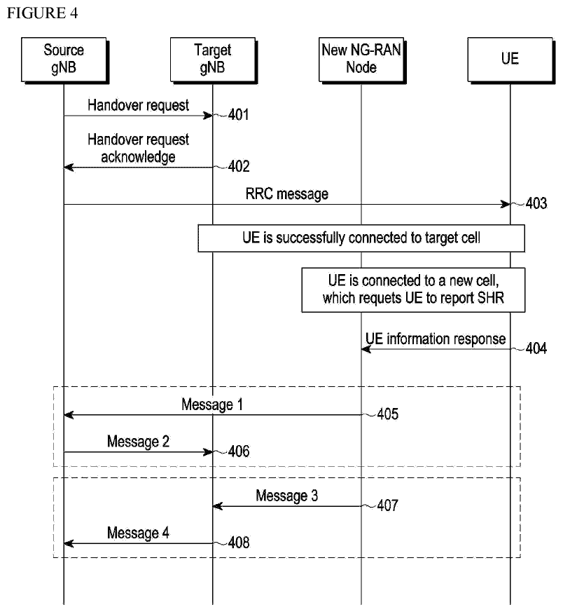

FIG. 4 is a schematic diagram of Embodiment 2, including the following operations:

Operation 401: the source gNB decides to handover the UE to the target cell. The source gNB transmits an Xn message handover request message, such as HANDOVER REQUEST, to the target gNB, which includes at least one of:
T310-related information;
T312-related information;
T304-related information;
information indicating that the threshold value of the elapsed time of T304 is decided by the target node, for example, a flag;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

The details of the T310/T312/T304-related information, the CHO-related threshold, the data plane measurement, and the UP measurements-related information may refer to the description in Embodiment 1.

If the message does not include the T304-related information but includes the T310-related information and/or the T312-related information, or the message includes the flag indicating that the threshold value of the elapsed time of T304 is decided by the target cell, the target cell may decide the threshold value of the elapsed time of T304 by itself.

The target cell may decide the activation conditions of the SHR according to the information included in the message. For example, deciding the threshold value of the elapsed time of T310, and/or the threshold value of the elapsed time of T312, and/or the threshold value of the elapsed time of T304, and/or the CHO-related threshold, and/or the threshold value of the difference between the time when the recent radio link problem occurs in the UE and the time when the handover is successful. Whether to start the UP measurements and related configuration parameters may further be decided.

Operation 402: the target cell generates an Xn message handover request acknowledgement, such as HANDOVER REQUEST ACKNOWLEDGE. According to the existing mechanism, the message includes handover-related configuration information, such as random access-related configuration information. The message further includes at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

The information may be decided by the source cell or the target cell. If the information is decided by the source cell, the target cell uses the values of the information included in the previous operation; and if the information is decided by the target cell, the target cell may decide the values of the information by itself.

The information may also be included in an RRC container in the message.

The target cell transmits the message to the source cell.

Operation 403: the source cell generates an RRC message according to the information received in the previous operation. According to the existing mechanism, the message includes handover-related configuration information, such as random access-related configuration information. The message further includes the handover-related configuration information, and at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information.

The information may be used as the activation condition of the SHR. For example, if the message includes the threshold value of the elapsed time of T310, when timer T310 is started and the elapsed time is longer than the threshold value of the elapsed time of T310, the UE records and saves the SHR; and if the message includes the threshold value of the difference between the time when the recent radio link problem occurs in the UE and the time when the handover is successful, when the difference between the time when the recent radio link problem occurs in the UE and the time when the handover is successful is smaller than the corresponding threshold value, the UE records and saves the SHR. The processing of the remaining threshold values is similar to this. For another example, if the message includes the flag indicating that the UE is required to record the SHR when the activation condition 4 is satisfied, in the DAPS handover process, if the activation condition 4 is satisfied, the UE records and saves the SHR. For another example, the message includes the UP measurements-related information, and the UE may record UP measurements results. For another example, when the UE performs the handover, the NR-U radio link problem occurs in the UE in the source cell, for example, the RSSI measured by the UE in the source cell exceeds the threshold value of the RSSI of the source cell, and the duration exceeds the threshold value of the duration, the UE records and saves the SHR; and the difference between the time when the NR-U radio link problem occurs in the UE after the UE performs the handover successfully and the time when the handover is successful is less than, or less than or equal to, or equal to the corresponding threshold value, the UE records and saves the SHR.

The RRC message may include, but is not limited to, at least one of: RRCReconfiguration, HandoverCommand, MobilityFromNRCommand.

The source cell transmits the message to the UE.

The UE performs the handover and successfully connects to the target cell. The UE records and saves the SHR according to the information in the message.

The SHR may include at least one of:
a cell identity of the source cell;
a cell identity of the target cell;
a measurement result of the source cell;
a measurement result of the target cell;
a measurement result of a neighboring cell;
a measurement result of a candidate target cell in the CHO;
a flag indicating that a radio link failure occurs on the source cell in the DAPS handover;
a difference between a time when the UE receives CHO configuration-related information and a time when the UE performs the CHO in the CHO;
location information of the UE;
information indicating that elapsed time of T310 is too long, for example, a flag;
information indicating that elapsed time of T312 is too long, for example,
a flag;
information indicating that elapsed time of T304 is too long, for example,
a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too large, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312.

The details of the cell identity, the starting time being too long, and the UP measurements result-related information may refer to Embodiment 1.

The information included in the SHR is related to the radio link problems that occur in the handover process. The UE may also generate SHRs encoded in different formats according to the related radio link problems.

For example, if the radio link problem is related to the source cell, for example, if the elapsed time of T310 is too long, the SHR includes information indicating that the elapsed time of T310 is too long, and optionally, it may also include the measurement results of the source cell and/or the target cell and/or neighboring cell, and/or the cell identity of the source cell, and/or the cell identity of the target cell. The measurement result is measured when the UE is connected to the source cell, and the SHR generated by the UE is encoded in the RAT format of the source cell.

For another example, if the radio link problem is related to the target cell, for example, if the elapsed time of T304 is too long, the SHR includes information indicating that the elapsed time of T304 is too long, and optionally, a part or all of the random access-related configuration information, and/or the cell identity of the source cell, and/or the cell identity of the target cell. The random access-related configuration information is generated by the target cell and encoded in the RAT format of the target cell, and the SHR generated by the UE is encoded in the RAT format of the target cell.

In the embodiment, the RATs of the source cell and the target cell are the same, which both are NR.

The UE generates an SHR, which is encoded in an NR format.

The UE is connected to a new cell, and a node where the new cell is located may be a gNB, that is, the RAT of the new cell is NR, or an ng-eNB, that is, the RAT of the new cell is LTE. The new cell may be the same as or different from the target cell.

The new cell may request the UE to report the SHR according to the existing mechanism.

Operation 404, the UE transmits an RRC message UE information response, such as UEInformationResponse, to the new cell. The message includes the SHR.

Different cells should be responsible for analyzing different information in the SHR according to the related radio link problems, for example, if the SHR includes the problem of random access in the target cell and/or the random access-related configuration information in the target cell, the SHR should be analyzed by the target cell; and if the SHR includes information indicating that the starting time of T310 is too long, the SHR should be analyzed by the source cell.

The SHR should be forwarded by the new cell to the cell responsible for analyzing the SHR for the node to analyze and judge the problem. There are different methods to decide which cell the cell responsible for analyzing the SHR is.

Method 1: the cell responsible for analyzing the SHR is the source cell for the handover.

If the RAT of the new cell is the same as that of the SHR, which both are NR, the SHR may be directly transmitted to the new cell. The new cell may read the SHR and determine the source cell by the cell identity of the source cell therein.

If the RAT of the new cell is different from that of the SHR, for example, the RAT of the new cell is LTE, the SHR is included in a container in the message. A cell identity is added outside the container. The cell identity is the cell identity of the source cell.

In this way, the new cell may determine the source cell according to the cell identity outside the container or the cell identity of the source cell in the SHR, so that the SHR may be forwarded to the source cell.

Method 2: the node responsible for analyzing the SHR is the target cell for the handover.

If the RAT of the new cell is the same as that of the SHR, which both are NR, the SHR may be directly transmitted to the new cell. The new cell may read the SHR and determine the target cell by the cell identity of the target cell therein.

If the RAT of the new cell is different from that of the SHR, for example, the RAT of the new cell is LTE, the SHR is included in a container in the message. A cell identity is added outside the container. The cell identity is the cell identity of the target cell.

In this way, the new cell may determine the target cell according to the cell identity outside the container or the cell identity of the target cell in the SHR, so that the SHR may be forwarded to the target cell.

Method 3: the UE decides the cell responsible for analyzing the SHR according to the related radio link problems.

As described above, different cells should be responsible for analyzing different information in the SHR according to the related radio link problems.

The UE may decide which cell should be responsible for analyzing the SHR according to the related radio link problems.

If the RAT of the new cell is the same as that of the SHR, which both are NR, the UE may add a flag in the SHR to indicate which cell should be responsible for analyzing the SHR. The new cell may read the SHR, and determine which cell should be responsible for analyzing the SHR through the flag therein, and/or the cell identity of the source cell, and/or the cell identity of the target cell.

If the RAT of the new cell is different from that of the SHR, for example, the RAT of the new cell is LTE, the SHR is included in a container in the message. A cell identity is added outside the container. If the UE decides that the target cell should be responsible for analyzing the SHR, the cell identity is the cell identity of the target cell; and if the UE decides that the source cell should be responsible for analyzing the SHR, the cell identity is the cell identity of the source cell.

In this way, the new cell may determine which cell should be responsible for analyzing the SHR according to the cell identity outside the container, or the flag, and/or the cell identity of the source cell, and/or the cell identity of the target cell in the SHR, so that the SHR may be forwarded to the cell.

Operation 405: it corresponds to the situation where the cell responsible for analyzing the SHR is the source cell in Method 1 or Method 3.

The new cell transmits a message 1 to the source cell, which includes the SHR.

The message is an Xn message, which may include, but is not limited to, at least one of: ACCESS AND MOBILITY INDICATION, HANDOVER REPORT, and a newly defined Xn message.

Since the RAT of the SHR is the same as that of the source cell, the source cell may read the SHR.

The source cell may analyze and judge the problem according to content of the SHR, and perform optimization.

If the source cell judges that some information included in the SHR should be analyzed by the target cell, the source cell may know which cell the target cell is according to the information in the SHR. The source cell may pick a part or all of the information in the SHR and transmit it to the target cell.

For example, the source cell may judge that the reason why the UE has been configured with the CHO-related configuration information but does not perform the CHO handover may be improper configuring of parameters in the CHO-related configuration information, according to the information indicating that the UE has not performed the CHO handover and receives configuration information for the legacy handover or the DAPS handover after receiving the CHO-related configuration information and/or the information indicating that a difference between the time when the UE receives the CHO configuration-related information and a time when the UE performs the handover during the CHO procedure is too large in the SHR, and the source cell may optimize the parameters.

For another example, the source cell may judge that, although this handover is successful, it needs to be optimized due to long service interruption time, according to the UP measurements result-related information in the SHR, such as the service interruption time, and/or the list of DRB information in the corresponding source cell, and/or the time interval of packets before the handover.

Operation 406: the source cell transmits a message 2 to the target cell, which includes a part or all of the information in the SHR.

The message is an Xn message, which may include, but is not limited to, at least one of: ACCESS AND MOBILITY INDICATION, HANDOVER REPORT, and a newly defined Xn message.

The target cell may analyze and judge the problem according to the information, and perform optimization

For example, the target cell may judge that random access-related parameters may be improperly configured according to the information indicating that the elapsed time of T304 is too long in the SHR, and the target cell may optimize the parameters.

For another example, the source cell may judge that, although the handover is successful, it needs to be optimized (for example, selecting a more suitable DRB) due to long service interruption time, according to the UP measurements result-related information in the SHR, such as the service interruption time, and/or the list of DRB information of the corresponding target cell, and/or the time interval of packets before the handover.

Operation 407: it corresponds to the situation where the cell responsible for analyzing the SHR is the target cell in Method 1 or Method 3.

The new cell transmits a message 3 to the target cell, which includes the SHR.

The message is an Xn message, which may include, but is not limited to, at least one of: ACCESS AND MOBILITY INDICATION, HANDOVER REPORT, and a newly defined Xn message.

Since the RAT of the SHR is consistent with that of the target cell, the target cell may read the SHR.

The target cell may analyze and judge the problem according to content of the SHR, and perform optimization.

If the target cell judges that some information included in the SHR should be analyzed by the source cell, the target cell may know which cell the source cell is according to the information in the SHR. The target cell may pick a part or all of the information in the SHR and transmit it to the source cell.

Operation 408: the target cell transmits a message 4 to the source cell, which includes a part or all of the information in the SHR.

The message is an Xn message, which may include, but is not limited to, at least one of: ACCESS AND MOBILITY INDICATION, HANDOVER REPORT, and a newly defined Xn message.

The source cell may analyze and judge the problem according to the information, and perform optimization.

Through the above operations, the network may analyze the SHR, and judge whether self-optimization and self-configuration are needed according to the information in the SHR, such as optimization of the handover timing, optimization of selection of the target cell, optimization of handover-related parameters, so that the network performance and user experience are improved.

Embodiment 3 describes a situation where the UE receives configuration information of an SHR and reports the SHR according to the configuration information after successful handover in a 5G system.

The handover is Xn interface-based handover, which may be legacy handover, CHO or DAPS handover.

A source gNB is a gNB where the source cell is located, and a target ng-eNB is an ng-eNB where the target cell is located. A new NG-RAN node may be either a gNB or an ng-eNB.

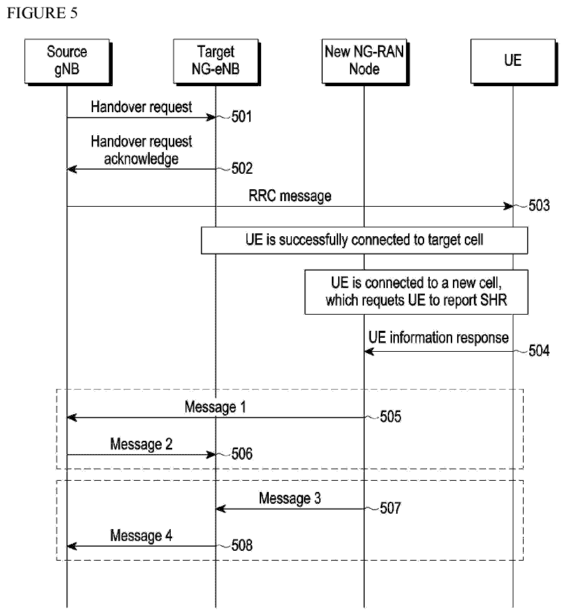

FIG. 5 is a schematic diagram of Embodiment 3, which includes the following operations:

Operations 501 to 503: the same as operations 401 to 403.

The UE performs the handover and is successfully connected to the target cell. The UE records and saves the SHR according to the information in the message in operation 503.

The SHR may include at least one of:
a cell identity of the source cell;
a cell identity of the target cell;
a measurement result of the source cell;
a measurement result of the target cell;
a measurement result of a neighboring cell;
a measurement result of a candidate target cell in the CHO;
a flag indicating that a radio link failure occurs on the source cell in the DAPS handover;
a difference between a time when the UE receives CHO configuration-related information and a time when the UE performs the CHO in the CHO;
location information of the UE;
information indicating that elapsed time of T310 is too long, for example, a flag;
information indicating that elapsed time of T312 is too long, for example, a flag;
information indicating that elapsed time of T304 is too long, for example, a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too large, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312.

The details of the cell identity, the starting time being too long, and the UP measurements result-related information may refer to Embodiment 1.

The information included in the SHR is related to the radio link problems that occur in the handover process. The UE may also generate SHRs encoded in different formats according to the related radio link problems.

For example, if the radio link problem is related to the source cell, for example, if the elapsed time of T310 is too long, the SHR includes information indicating that the elapsed time of T310 is too long, and optionally, it may also include the measurement results of the source cell and/or the target cell and/or neighboring cell, and/or the cell identity of the source cell, and/or the cell identity of the target cell. The measurement result is measured when the UE is connected to the source cell, and the SHR generated by the UE is encoded in the RAT format of the source cell.

For another example, if the radio link problem is related to the target cell, for example, if the elapsed time of T304 is too long, the SHR includes information indicating that the elapsed time of T304 is too long, and optionally, a part or all of the random access-related configuration information, and/or the cell identity of the source cell, and/or the cell identity of the target cell. The random access-related configuration information is generated by the target cell and encoded in the RAT format of the target cell, and the SHR generated by the UE is encoded in the RAT format of the target cell.

When there are both a radio link problem related to the source cell and a radio link problem related to the target cell, the UE may generate different SHRs and encode them in different RAT formats.

In the embodiment, the RAT of the source cell is different from that of the target cell, and the RAT of the source cell is NR, and the RAT of the target cell is LTE.

If the radio link problem occurring in the handover process is only related to the source cell, the UE generates an SHR, which is encoded in an RAT format, i.e., the RAT of the source cell; and if the radio link problem occurring in the handover process is only related to the target cell, the UE generates an SHR, which is encoded in an RAT format, i.e., the RAT of the target cell. If it belongs to these two cases, the subsequent process may refer to Embodiment 2, which will not be described in detail below.

If both the radio link problem related to the source cell and the radio link problem related to the target cell occur in the handover process, there are different methods to decide the encoding format of the SHR:

Method A: the UE generates a list of SHRs. The list includes at least one SHR in the NR format, and optionally, information indicating which format the SHR is encoded in, for example, a flag; and at least one SHR in an LTE format, and optionally, information indicating which format the SHR is encoded in, for example, a flag.

Method B: the UE generates a nested SHR, for example, the UE generates an SHR in the NR format, which includes a container for including an SHR in the LTE format; and vice versa. The UE may choose which format of SHR to generate, for example, according to the RAT of a cell responsible for analyzing the SHR decided by the UE. If the RAT of the cell, decided by UE and responsible for analyzing the SHR, is NR, the UE generates an SHR in the NR format, which includes a container for including an SHR in the LTE format; and if the RAT of the cell, decided by UE and responsible for analyzing the SHR, is LTE, the UE generates an SHR in the LTE format, which includes a container for including an SHR in the NR format.

The UE is connected to a new cell, and a node where the new cell is located may be a gNB, that is, RAT of the new cell is NR, or an ng-eNB, that is, the RAT of the new cell is LTE. The new cell may be the same as or different from the target cell.

The new cell may request the UE to report the SHR according to the existing mechanism.

Operation 504: the UE transmits a message to the new cell. The message includes the SHR.

If the RAT of the new cell is NR, the message is an NR RRC message UEInformationResponse; and if the RAT of the new cell is LTE, the message is an LTE RRC message UEInformationResponse.

Different cells should be responsible for analyzing different information in the SHR according to the related radio link problems, for example, if the SHR includes the problem of random access in the target cell and/or the random access-related configuration information in the target cell, the SHR should be analyzed by the target cell; and if the SHR includes information indicating that the starting time of T310 is too long, the SHR should be analyzed by the source cell.

The SHR should be forwarded by the new cell to the cell responsible for analyzing the SHR for the node to analyze and judge the problem. There are different methods to decide which cell the cell is.

Method 1: the cell responsible for analyzing the SHR is the source cell for the handover.

If the UE generates a nested SHR:
in the embodiment, the RAT of the source cell is NR, and the UE generates an SHR in the NR format, which includes a container for including an SHR in the LTE format.

If the RAT of the new cell is NR, the new cell may read the SHR and determine which cell the source cell is by the cell identity of the source cell therein.

If the RAT of the new cell is LTE, the SHR is included in a container in the message. A cell identity is added outside the container. The cell identity is the cell identity of the source cell.

In this way, the new cell may judge which cell the source cell is according to the cell identity outside the container or the cell identity of the source cell in the SHR, so that the SHR may be forwarded to the source cell.

If the UE generates a list of SHRs:
the list of SHRs includes at least one SHR in the NR format, and at least one container. The container includes SHRs in the LTE format in the list, and optionally, information indicating that the SHRs are encoded in the LTE format, for example, a flag, is added outside the container.

If the RAT of the new cell is NR, the new cell may read SHRs in the NR format in the list, and determine which cell the source cell is by the cell identity of the source cell therein.

If the RAT of the new cell is LTE, the list of SHRs may be included in a container. A cell identity is added outside the container. The cell identity is the cell identity of the source cell.

In this way, the new cell may judge which cell the source cell is according to the cell identity outside the container or the cell identity of the source cell in the readable SHR, so that the SHR may be forwarded to the source cell.

Method 2: the node responsible for analyzing the SHR is the target cell for the handover.

If the UE generates a nested SHR:
in the embodiment, the RAT of the target cell is LTE, and the UE generates an SHR in the LTE format, which includes a container for including an SHR in the NR format.

If the RAT of the new cell is LTE, the new cell may read the SHR and determine which cell the target cell is by the cell identity of the target cell therein.

If the RAT of the new cell is NR, the SHR is included in a container in the message. A cell identity is added outside the container. The cell identity is the cell identity of the target cell.

In this way, the new cell may judge which cell the target cell is according to the cell identity outside the container or the cell identity of the target cell in the SHR, so that the SHR may be forwarded to the target cell.

If the UE generates a list of SHRs:
the list of SHRs includes at least one SHR in the LTE format, and at least one container. The container includes SHRs in the NR format in the list, and optionally, information indicating that the SHRs are encoded in the LTE format, for example, a flag, is added outside the container.

If the RAT of the new cell is LTE, the new cell may read SHRs in the LTE format in the list, and determine which cell the target cell is through the cell identity of the target cell therein.

If the RAT of the new cell is NR, the list of SHRs may be included in a container. A cell identity is added outside the container. The cell identity is the cell identity of the target cell.

In this way, the new cell may judge which cell the target cell is according to the cell identity outside the container or the cell identity of the target cell in the readable SHR, so that the SHR may be forwarded to the target cell.

Method 3: the UE decides the cell responsible for analyzing the SHR according to the information in the SHR.

As described above, different cells should be responsible for analyzing different information in the SHR according to the related radio link problems.

The UE may judge which cell should be responsible for analyzing the SHR according to the related radio link problems.

If the UE generates a nested SHR:
if the UE judges that the SHR should be analyzed by the source cell, the UE generates an SHR in the NR format, which includes a container for including an SHR in the LTE format.

If the RAT of the new cell is NR, the UE may add a flag in the SHR to indicate which cell should be responsible for analyzing the SHR. The new cell may read the SHR, and judge which cell should be responsible for analyzing the SHR through the flag therein, and/or the cell identity of the source cell, and/or the cell identity of the target cell.

If the RAT of the new cell is LTE, the SHR may be included in a container. A cell identity is added outside the container. The cell identity is the cell identity of the source cell.

If the UE judges that the SHR should be analyzed by the target cell, the UE generates an SHR in the LTE format, which includes a container for including an SHR in the NR format.

If the RAT of the new cell is LTE, the UE may add a flag in the SHR to indicate which cell should be responsible for analyzing the SHR. The new cell may read the SHR, and judge which cell should be responsible for analyzing the SHR through the flag therein, and/or the cell identity of the source cell, and/or the cell identity of the target cell.

If the RAT of the new cell is NR, the SHR may be included in a container. A cell identity is added outside the container. The cell identity is the cell identity of the target cell.

In this way, the new cell may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

If the UE generates a list of SHRs:
if the UE judges that the source cell should be responsible for analyzing the SHR, it is processed as described in Method 1.
if the UE judges that the target cell should be responsible for analyzing the SHR, it is processed as described in Method 2.
the list of SHRs may also be encoded in the RAT format of the new cell, including at least one SHR in a format the same as the RAT format, and at least one container. The container includes SHRs in formats different from the RAT format in the list. Optionally, information indicating which format the SHR is encoded in, for example, a flag, is added outside the container. The UE may add a flag in the SHR in a format which is the same as the RAT format to indicate which cell should be responsible for analyzing the SHR.
the UE may also generate at least two containers. A first container includes at least one SHR in the NR format, and a cell identity is added outside the container, where the cell identity is the cell identity of the source cell. A second container includes at least one SHR in the LTE format, and a cell identity is added outside the container, where the cell identity is the cell identity of the target cell.

In this way, the new cell may judge which cell should be responsible for analyzing the SHR according to the cell identity outside the container, or the flag, and/or the cell identity of the source cell, and/or the cell identity of the target cell in the readable SHR, so that the SHR may be forwarded to the cell.

Operation 505: it corresponds to the situation where the cell responsible for analyzing the SHR is the source cell in Method 1 or Method 3.

The new cell transmits a message 1 to the source cell, which includes an SHR or a list of SHRs.

The message is an Xn message, which may include, but is not limited to, at least one of: ACCESS AND MOBILITY INDICATION, HANDOVER REPORT, and a newly defined Xn message.

If it is an SHR, the SHR is in the NR format:

Since the RAT of the SHR is consistent with that of the source cell, the source cell may read the SHR.

The source cell may analyze and judge the problem according to content of the SHR, and perform optimization.

If the source cell judges that some information included in the SHR should be analyzed by the target cell, the source cell may know which cell the target cell is according to the information in the SHR. The source cell may pick a part or all of the information in the SHR, such as the container including the SHRs in the LTE format, and transmit it to the target cell.

If the SHR information includes a list of SHRs:

The source cell may analyze and judge the problem according to content of the SHRs in the NR format in the lists of SHRs, and perform optimization.

The source cell may transmit content in the container to the target cell according to the target cell of the information in the SHR or the cell identity outside the container in the list of SHRs (the target cell in this embodiment).

Operation 506: the source cell transmits a message 2 to the target cell, which includes a part or all of the information in the SHR, and/or the container in the list of SHRs.

The message is an Xn message, which may include, but is not limited to, at least one of: ACCESS AND MOBILITY INDICATION, HANDOVER REPORT, and a newly defined Xn message.

The target cell may analyze and judge the problem according to the information or information in the container, and perform optimization.

Operation 507: it corresponds to the scenario where the cell responsible for analyzing the SHR is the target cell in Method 1 or Method 3.

The new cell transmits a message 3 to the target cell, which includes an SHR or a list of SHRs.

The message is an Xn message, which may include, but is not limited to, at least one of: ACCESS AND MOBILITY INDICATION, HANDOVER REPORT, and a newly defined Xn message.

If it is an SHR, the SHR is in the LTE format:

Since the RAT of the SHR is consistent with that of the target cell, the target cell may read the SHR.

The target cell may analyze and judge the problem according to content of the SHR, and perform optimization.

If the target cell judges that some information included in the SHR should be analyzed by the target cell, the target cell may know which cell the source cell is according to the information in the SHR. The target cell may pick a part or all of the information in the SHR, such as the container including the SHRs in the NR format, and transmit it to the source cell.

If the SHR information includes a list of SHRs:

The target cell may analyze and judge the problem according to content of the SHRs in the LTE format in the list of SHRs, and perform optimization.

The target cell may transmit content in the container to the source cell according to the source cell of the information in the SHR or the cell identity outside the container in the list of SHRs (the source cell in this embodiment).

Operation 506: the target cell transmits a message 4 to the source cell, which includes a part or all of the information in the SHR, and/or the container in the list of SHRs.

The message is an Xn message, which may include, but is not limited to, at least one of: ACCESS AND MOBILITY INDICATION, HANDOVER REPORT, and a newly defined Xn message.

The source cell may analyze and judge the problem according to the information or information in the container, and perform optimization.

Through the above operations, the network may analyze the SHR, and judge whether self-optimization and self-configuration are needed according to the information in the SHR, such as optimization of the handover timing, optimization of selection of the target cell, optimization of handover-related parameters, so that the network performance and user experience are improved.

Embodiment 4 describes a situation that the UE reports the SHR to an access node in a 5G system.

The access node may be a gNB, an ng-eNB, an eNB, or an en-gNB.

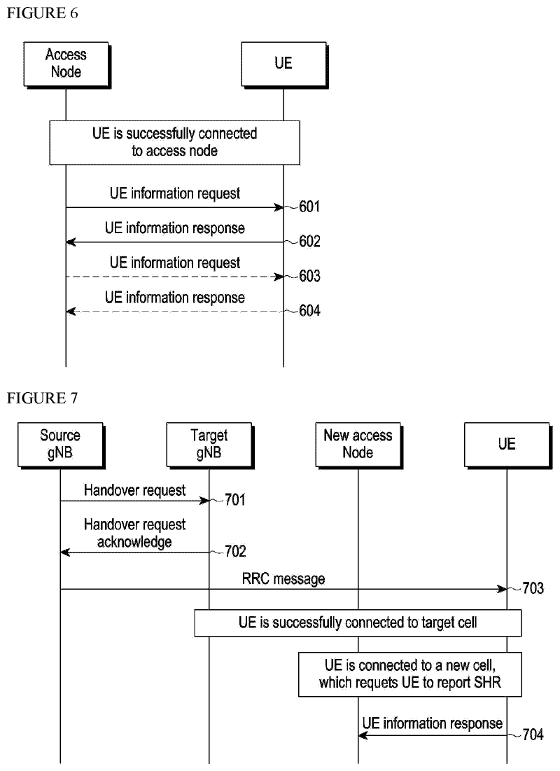

FIG. 6 is a schematic diagram of Embodiment 4, which includes the following operations:

The UE is connected to a cell of the access node after performing a successful handover. The handover may be legacy handover, DAPS handover, or CHO. The access node may also be the target node, or a new access node to which the UE is connected after leaving the target node.

In the connection process, the UE reports to the node that an SHR, and an RA report and/or an RLF report are generated in the handover process.

Operation 601: the access node transmits an RRC message to the UE, such as UE information request UEInformationRequest.

The message may be an NR RRC message or an LTE RRC message.

The message carries information requesting the UE to report the SHR and/or the RA report and/or the RLF report.

Operation 602: the UE transmits an RRC message to the access node, such as UE information response UEInformationResponse.

The message may be an NR RRC message or an LTE RRC message.

Since the SHR report, and/or the RA report, and/or the RLF report are generated in a handover process, there is an association relationship therebetween. The method for associating the reports is as follows:

Method 1: the SHR includes content of the RA report and/or the RLF report. For example, one or more containers are added to the SHR to include the RA report and/or the RLF report.

Alternatively, the RA report or the RLF report includes content of the SHR. For example, a container is added to the RA report or the RLF report to include the SHR report.

Method 2: the same information is added to the RA report and/or the RLF report, and the SHR.

The information may be at least one of:
time stamp information;
an identification, such as C-RNTI and/or RA-RNTI and/or Preamble;
a number, such as a serial number;
a flag.

When the information is included in the SHR and in the RA report and/or the RLF report, and values of the information are the same, it may be considered that there is an association relationship between the SHR and the RA report and/or the RLF report.

Method 3: information is added to the SHR to indicate that the UE generates the RA report and/or the RLF report in an association relationship. Alternatively, information is added to the RA report and/or the RLF report to indicate that the UE generates the SHR in an association relationship.

According to the information in the previous operation, the UE may report the SHR, and the RA report and/or the RLF report together, or report the SHR separately, or report the RA report and/or the RLF report separately in this operation.

Operation 603: the access node transmits an RRC message to the UE, such as UE information request UEInformationRequest.

The message may be an NR RRC message or an LTE RRC message.

If the SHR is reported separately in the previous operation, the access node may judge that the UE also generates the RA report and/or the RLF report in an association relationship according to the information included in Method 2 or Method 3 in the previous operation. The message carries information requesting the UE to report the RA report and/or the RLF report.

If the RA report and/or the RLF report are reported separately in the previous operation, the access node may judge that the UE also generates the SHR in an association relationship according to the information included in Method 2 or Method 3 in the previous operation. The message carries information requesting the UE to report the SHR.

Operation 604: the UE transmits an RRC message to the access node, such as UE information response UEInformationResponse.

The message may be an NR RRC message or an LTE RRC message.

The UE reports the reports according to the request of the access node.

The access node may forward the reports to other nodes, and the access node or other nodes may associate the reports according to the SHR and the RA report and/or the information in SHR, and analyze the reports together, so as to judge the problem in the handover and optimize handover-related parameters, thereby improving the network performance and reducing the possibility of radio link failure in the handover.

Embodiment 5 describes a situation where the UE receives configuration information of an SHR and reports the SHR according to the configuration information after successful handover in a 5G system.

The 5G system is deployed in an NR-U band.

The handover is Xn interface-based handover, which may be legacy handover, CHO or DAPS handover.

A source gNB is a gNB where the source cell is located, and a target gNB is a gNB where the target cell is located. A new NG-RAN node may be either a gNB or an ng-eNB.

FIG. 7 is a schematic diagram of Embodiment 5, which includes the following operations:

Operation 701: the source gNB decides to handover the UE to the target cell. The source gNB transmits an Xn message HANDOVER REQUEST to the target gNB, which includes at least one of:
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The details of the identifier of the BWP, the identifier of the channel, and the NR-U radio link problem may refer to Embodiment 1, which will not be described in detail here.

Operation 702, the target cell generates an Xn message HANDOVER REQUEST ACKNOWLEDGE. According to the existing mechanism, the message includes handover-related configuration information, such as random access-related configuration information. The message further includes at least one of:
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The information may be decided by the source cell or the target cell. If the information is decided by the source cell, the target cell uses the values of the information included in the previous operation; and if the information is decided by the target cell, the target cell may decide the values of the information by itself.

The information may also be included in an RRC container in the message.

The target cell transmits the message to the source cell.

Operation 703: the source cell generates an RRC message according to the information received in the previous operation. According to the existing mechanism, the message includes handover-related configuration information, such as random access-related configuration information. The message further includes the handover-related configuration information, and at least one of:
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The information may be used as the activation condition of the SHR. For example, when the UE performs the handover, the NR-U radio link problem occurs in the UE in the source cell, for example, the RSSI measured by the UE in the source cell exceeds the threshold value of the RSSI of the source cell, and the duration exceeds the threshold value of the duration, the UE records and saves the SHR; and the difference between the time when the NR-U radio link problem occurs in the UE after the UE performs the handover successfully and the time when the handover is successful is less than, or less than or equal to, or equal to the corresponding threshold value, the UE records and saves the SHR.

The RRC message may include, but is not limited to, at least one of: RRCReconfiguration, HandoverCommand, MobilityFromNRCommand.

The source cell transmits the message to the UE.

The UE performs the handover and is successfully connected to the target cell. The UE record and saves the SHR according to the information in the message.

The SHR may include at least one of:
a problem type;
an identifier of a BWP and/or a channel where the problem occurs;
an NR-U related measurement report on the BWP and/or channel;
NR-U related measurement reports on other BWPs and/or channels;
an ED threshold;
a maximum ED threshold;
an ED threshold offset (energyDetectionThresholdOffset, indicating an offset from a default value of the maximum ED threshold);
a flag indicating whether there are other access technologies using the same band resources (absenceOfAnyOtherTechnology);
a channel access priority (channelAccessPriority).

The details of the problem type and the NR-U related measurement reports may refer to Embodiment 1, which will not be described in detail here.

The UE is connected to a new cell, and the new cell may request the UE to report the SHR according to the existing mechanism.

Operation 704, the UE transmits an RRC message to the new cell, such as UE information response UEInformationResponse. The message includes the SHR.

For the subsequent processing of the SHR, the description in Embodiment 1, Embodiment 2, or Embodiment 3 may be referred to, which will not be described in detail here.

Through the above operations, the network may analyze the SHR, and judge whether self-optimization and self-configuration are needed according to the information in the SHR, such as optimization of the handover timing, optimization of selection of the target cell, optimization of handover-related parameters, so that the network performance and user experience are improved.

Embodiment 6 describes a situation where the access node responsible for analyzing the SHR consists of a CU and a DU.

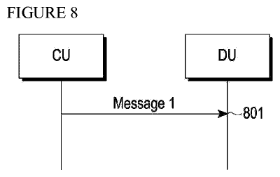

FIG. 8 is a schematic diagram of Embodiment 6, which includes the following operations:

Operation 801: the CU transmits a message 1 to the DU after receiving an SHR from other access nodes.

The message may be transmitted using an F1 interface.

When the F1 interface is used, the message 1 may include, but is not limited to, at least one of: GNB-CU CONFIGURATION UPDATE, ACCESS AND MOBILITY INDICATION, and a newly defined Xn message.

The message includes at least one of:
a cell identity of the source cell;
a cell identity of the target cell;
a measurement result of the source cell;
a measurement result of the target cell;
a measurement result of a neighboring cell;
a measurement result of a candidate target cell in the CHO;
a flag indicating that a radio link failure occurs on the source cell in the DAPS handover;
a difference between a time when the UE receives CHO configuration-related information and a time when the UE performs the CHO in the CHO;
location information of the UE;
information indicating that elapsed time of T310 is too long, for example,
a flag;
information indicating that elapsed time of T312 is too long, for example,
a flag;
information indicating that elapsed time of T304 is too long, for example, a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too long, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312;
a problem type;
an identifier of a BWP and/or a channel where the problem occurs;
an NR-U related measurement report on the BWP and/or channel;
NR-U related measurement reports on other BWPs and/or channels;
an ED threshold;
a maximum ED threshold;
an ED threshold offset (energyDetectionThresholdOffset, indicating an offset from a default value of the maximum ED threshold);
a flag indicating whether there are other access technologies using the same band resources (absenceOfAnyOtherTechnology);
a channel access priority (channelAccessPriority);
a container, including SHRs in different RAT formats;
a container, including an RA report;
a container, including an RLF report;
information for associating the RA report and/or the RLF report, such as time stamp information, and/or an identification (such as C-RNTI and/or RA-RNTI and/or Preamble), and/or a number (such as serial number), and/or a flag;
information for indicating that the UE generates the RA report and/or the RLF report in an association relationship, for example, a flag;
an identification of the UE, such as C-RNTI, and/or an identification of the UE in the DU, for example, gNB-DU UE FIAP ID;
random access configuration information;
a container, including the SHR received by the CU.

For the details of the information, one may refer to the description in Embodiment 1.

After receiving the information, the DU may analyze and judge whether optimization is needed, for example, random access-related parameters are improperly configured, for example, the value of T304 is improperly set, so that the DU may self-configure and self-optimize configuration parameters related to itself, thereby improving the network performance and user experience.

Embodiment 7 describes a situation where the UE receives configuration information of an SHR and reports the SHR according to the configuration information after successful handover in a wireless communication system.

The handover may be legacy handover, or CHO, or DAPS handover.

The source access node, and/or the target access node, and/or the new access node may be a gNB or an eNB or an en-gNB or an ng-eNB. A core network entity may be an AMF or an MME.

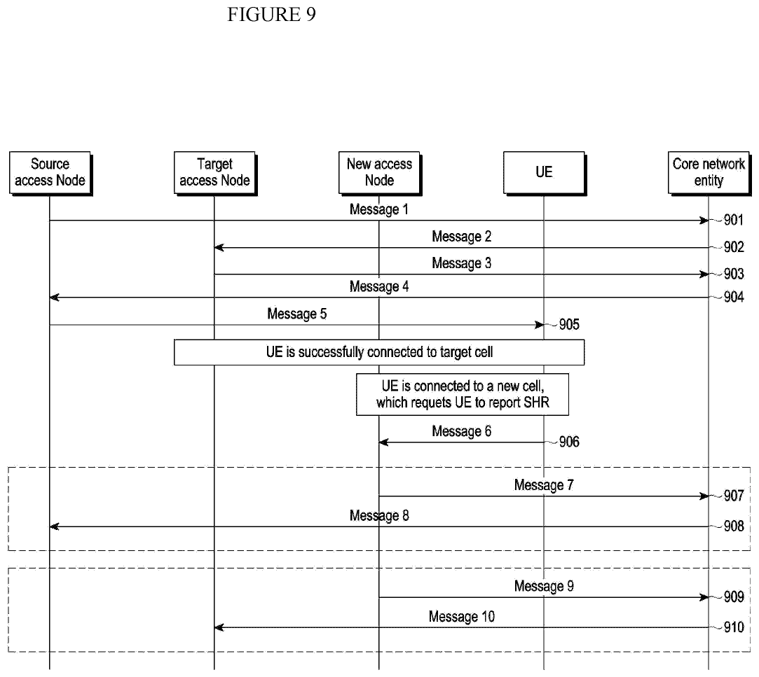

FIG. 9 is a schematic diagram of Embodiment 7, which includes the following operations:

Operation 900A: an access node 2 transmits a message OA to the core network entity, wherein the message 0 includes at least one of:

T304-related information;
a node identifier of an access node 1.

The T304-related information includes a value of timer T304 and/or a threshold value of the elapsed time of the timer of T304.

The node identifier includes a node ID and/or a cell identity of a cell to which the node belongs.

The message may be transmitted using an Ng interface or an S1 interface.

When the Ng interface is used, the message 1 may include, but is not limited to, at least one of: RAN CONFIGURATION UPDATE, UPLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE, eNB DIRECT INFORMATION TRANSFER, eNB CONFIGURATION TRANSFER, and a newly defined S1 message.

Operation 900B: the core network entity transmits a message OB to the access node 1. The message includes at least one of:
T304-related information;
a node identification of the access node 1.

The message may be transmitted using an Ng interface or an S1 interface.

When the Ng interface is used, the message 1 may include, but is not limited to, at least one of: RAN CONFIGURATION UPDATE ACKNOWLEDGE, AMF CONFIGURATION UPDATE, DOWNLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE ACKNOWLEDGE, MME CONFIGURATION UPDATE, MME DIRECT INFORMATION TRANSFER, MME CONFIGURATION TRANSFER, and a newly defined S1 message.

The access node 1 may decide the threshold value of the elapsed time of T304 according to the information included in the message as one of the activation conditions of the SHR.

Operations 900A to 900B are not necessary.

Operation 901: the access node 1 transmits a message 1 to the core network entity, which includes at least one of:
T310-related information;
T312-related information;
T304-related information;
information indicating that the threshold value of the elapsed time of T304 is decided by the target node, for example, a flag;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or
an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The details of the information may refer to the description in Embodiment 1.

The message may be transmitted using an Ng interface or an S1 interface.

When the Ng interface is used, the message 1 may include, but is not limited to, at least one of: RAN CONFIGURATION UPDATE ACKNOWLEDGE, AMF CONFIGURATION UPDATE, DOWNLINK RAN CONFIGURATION TRANSFER, HANDOVER REQUIRED, and a newly defined Ng message.

When an inter-node interface is the S1 interface, a message of the inter-node interface includes, but is not limited to, at least one of: ENB CONFIGURATION UPDATE ACKNOWLEDGE, MME CONFIGURATION UPDATE, MME DIRECT INFORMATION TRANSFER, MME CONFIGURATION TRANSFER, HANDOVER REQUIRED, and a newly defined S1 message.

Operation 902: the core network entity transmits a message 2 to the access node 2, which includes the information received in the previous operation.

The message may be transmitted using an Ng interface or an S1 interface.

When the Ng interface is used, the message 1 may include, but is not limited to, at least one of: RAN CONFIGURATION UPDATE ACKNOWLEDGE, AMF CONFIGURATION UPDATE, DOWNLINK RAN CONFIGURATION TRANSFER, HANDOVER REQUEST, and a newly defined Ng message.

When an inter-node interface is the S1 interface, a message of the inter-node interface includes, but is not limited to, at least one of: ENB CONFIGURATION UPDATE ACKNOWLEDGE, MME CONFIGURATION UPDATE, MME DIRECT INFORMATION TRANSFER, MME CONFIGURATION TRANSFER, HANDOVER REQUEST, and a newly defined S1 message.

The access node 2 may decide the activation conditions of the SHR according to the information included in the message. For example, deciding the threshold value of the elapsed time of T310, and/or the threshold value of elapsed time of T312, and/or the threshold value of elapsed time of T304, and/or the CHO-related threshold, and/or the threshold value of the difference between the time when the recent radio link problem occurs in the UE after the handover is successful and the time when the handover is successful. Whether to start the UP measurements and related configuration parameters may further be decided.

When the message is HANDOVER REQUEST, there are the following operations.

Operation 903: the access node 2 may generate a message 3 by referring to the information received in the previous operation or deciding the information by itself. According to the existing mechanism, the message includes handover-related configuration information, such as random access-related configuration information. The message includes at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or
an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of
the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The information may also be included in an RRC container in the message 3.

The message may be transmitted using an Ng interface or an S1 interface.

When the Ng interface is used, the message may include, but is not limited to, at least one of: HANDOVER REQUEST ACKNOWLEDGE, and a newly defined Ng message.

When an inter-node interface is the S1 interface, the message includes, but is not limited to, at least one of: HANDOVER REQUEST ACKNOWLEDGE, and a newly defined S1 message.

Operation 904: the core network entity transmits a message 4 to the access node 1, which includes the information received in the previous operation.

The message may be transmitted using an Ng interface or an S1 interface.

When the Ng interface is used, the message 1 may include, but is not limited to, at least one of: HANDOVER COMMAND, and a newly defined Ng message.

When an inter-node interface is the S1 interface, a message of the inter-node interface includes, but is not limited to, at least one of: HANDOVER COMMAND, and a newly defined S1 message.

Operation 905: the access node 1 generates a message 5 according to the information received in the previous operation. According to the existing mechanism, the message includes handover-related configuration information, such as random access-related configuration information. The message may further include at least one of:
a threshold value of the elapsed time of T310;
a threshold value of the elapsed time of T312;
a threshold value of the elapsed time of T304;
information indicating that the UE is required to record the SHR when activation condition 4 is satisfied, for example, a flag;
information indicating that the UE is required to record the SHR when the UE has not performed the handover and receives configuration information for the legacy handover or the DAPS handover after receiving the CHO-related configuration information, for example, a flag;
a CHO-related threshold;
a threshold value of a difference between a time when a recent radio link problem occurs in the UE after the handover is successful and a time when the handover is successful;
UP measurements-related information;
a threshold value of an RSSI, and/or a threshold value of duration, and/or an identifier of a BWP and/or an identifier of a channel for acquiring the RSSI, of the source cell;
a threshold value of CO, and/or the threshold value of the duration, and/or an identifier of a BWP and/or an identifier of a channel for acquiring the CO, of the source cell;
a threshold value of channel availability, and/or the threshold value of the duration, and/or an identifier of a BWP and/or an identifier of a channel for acquiring the channel availability, of the source cell;
a threshold value of an LBT success rate, and/or the threshold value of the duration, and/or an identifier of a BWP and/or an identifier of a channel for acquiring the LBT success rate, of the source cell;
a threshold value of an LBT failure rate, and/or the threshold value of the duration, and/or an identifier of a BWP and/or an identifier of a channel for acquiring the LBT failure rate, of the source cell;
a threshold value of an RSSI, and/or the threshold value of the duration, and/or an identifier of a BWP and/or an identifier of a channel for acquiring the RSSI, of the target cell;
a threshold value of CO, and/or the threshold value of the duration, and/or an identifier of a BWP and/or an identifier of a channel for acquiring the CO, of the target cell;
a threshold value of channel availability, and/or the threshold value of the duration, and/or an identifier of a BWP and/or an identifier of a channel for acquiring the channel availability, of the target cell;
a threshold value of an LBT success rate, and/or the threshold value of the duration, and/or an identifier of a BWP and/or an identifier of a channel for acquiring the LBT success rate, of the target cell;
a threshold value of an LBT failure rate, and/or the threshold value of the duration, and/or an identifier of a BWP and/or an identifier of a channel for acquiring the LBT failure rate, of the target cell;
a threshold value of a difference between a time when an NR-U radio link problem occurs in the UE after the handover is successful and a time when the handover is successful.

The message may be an NR RRC message or an LTE RRC message.

If it is the NR RRC message, the message may include, but is not limited to, at least one of: RRCReconfiguration, HandoverCommand, Mobility FromNRCommand, and a newly defined NR RRC message.

If it is the LTE RRC message, the message may include, but is not limited to, at least one of: RRCConnectionReconfiguration, HandoverCommand, Mobility FromEUTRACommand, and a newly defined LTE RRC message.

The information may be used as the activation condition of the SHR. For example, if the message includes the threshold value of the elapsed time of T310, when timer T310 is started and the elapsed time is longer than the threshold value of the elapsed time of T310, the UE records and saves the SHR; and if the message includes the threshold value of the difference between the time when the recent radio link problem occurs in the UE after the handover is successful and the time when the handover is successful, when the difference between the time when the recent radio link problem occurs in the UE after the handover is successful and the time when the handover is successful is smaller than the corresponding threshold value, the UE records and saves the SHR. The processing of the remaining threshold values is similar to this. For another example, if the message includes the flag indicating that the UE is required to record the SHR when the activation condition 4 is satisfied, in the DAPS handover process, if the activation condition 4 is satisfied, the UE records and saves the SHR. For another example, the message includes the UP measurements-related information, and the UE may record UP measurements results. For another example, when the UE performs the handover, the NR-U radio link problem occurs in the UE in the source cell, for example, the RSSI measured by the UE in the source cell exceeds the threshold value of the RSSI of the source cell, and the duration exceeds the threshold value of the duration, the UE records and saves the SHR; and the difference between the time when the NR-U radio link problem occurs in the UE after the UE performs the handover successfully and the time when the handover is successful is less than, or less than or equal to, or equal to the corresponding threshold value, the UE records and saves the SHR.

The access node 1 transmits the message 5 to the UE.

The UE performs the handover and is successfully connected to the access node 2. The UE records and saves the SHR according to the information in the message 5.

The SHR may include at least one of:
a cell identity of the source cell;
a cell identity of the target cell;
a measurement result of the source cell;
a measurement result of the target cell;
a measurement result of a neighboring cell;
a measurement result of a candidate target cell in the CHO;
a flag indicating that a radio link failure occurs on the source cell in the DAPS handover;
a difference between a time when the UE receives CHO configuration-related information and a time when the UE performs the CHO in the CHO;
location information of the UE;
information indicating that elapsed time of T310 is too long, for example, a flag;
information indicating that elapsed time of T312 is too long, for example,
a flag;
information indicating that elapsed time of T304 is too long, for example, a flag;
UP measurements result-related information;
information indicating that the UE has not performed the handover and receives configuration information for the legacy handover or the DAPS handover after receiving the CHO-related configuration information, for example, a flag;
information indicating that a difference between the time when the UE receives the CHO configuration-related information and a time when the UE performs the handover in the CHO is too large, for example, a flag;
information indicating whether the SHR should be analyzed by the source cell or the target cell, for example, a flag;
information indicating that T310 is started in a short time after the handover is successful, and/or the elapsed time of T310;
information indicating that T312 is started in a short time after the handover is successful, and/or the elapsed time of T312;
a problem type;
an identifier of a BWP and/or a channel where the problem occurs;
an NR-U related measurement report on the BWP and/or channel;
NR-U related measurement reports on other BWPs and/or channels;
an ED threshold;
a maximum ED threshold;
an ED threshold offset (energyDetectionThresholdOffset, indicating an offset from a default value of the maximum ED threshold);
a flag indicating whether there are other access technologies using the same band resources (absenceOfAnyOtherTechnology);
a channel access priority (channelAccessPriority).

For the details of the information, one may refer to the description in Embodiment 1.

The UE is connected to an access node 3. The access node 3 may be the same as or different from the access node 2. The access node 3 may require the UE to report the SHR according to the existing mechanism.

Operation 906: the UE transmits a message 6 to the access node 3. The message includes the SHR.

The message 6 may be an NR RRC message or an LTE RRC message.

If it is the NR RRC message, the message may include, but is not limited to, at least one of: UEInformationResponse, and a newly defined NR RRC message.

If it is the LTE RRC message, the message may include, but is not limited to, at least one of: UEInformationResponse, and a newly defined LTE RRC message.

The access node 3 judges which cell the SHR should be forwarded to, for example, according to the description in Embodiment 1, Embodiment 2, or Embodiment 3.

Operation 907: if the access node 3 judges that the SHR should be forwarded to the source cell, the access node 3 transmits a message 7 to the core network entity. The message includes at least one of:
the SHR.

The message may be transmitted using an Ng interface or an S1 interface.

When the Ng interface is used, the message 1 may include, but is not limited to, at least one of: RAN CONFIGURATION UPDATE, UPLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE, eNB DIRECT INFORMATION TRANSFER, eNB CONFIGURATION TRANSFER, and a newly defined S1 message.

Operation 908: the core network entity transmits a message 8 to the access node 1, which includes the information received in the previous operation.

The message 8 may be transmitted using an Ng interface or an S1 interface.

When the Ng interface is used, the message 1 may include, but is not limited to, at least one of: RAN CONFIGURATION UPDATE ACKNOWLEDGE, AMF CONFIGURATION UPDATE, DOWNLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE ACKNOWLEDGE, MME CONFIGURATION UPDATE, MME DIRECT INFORMATION TRANSFER, MME CONFIGURATION TRANSFER, and a newly defined S1 message.

The source cell may analyze and judge the problem according to content of the SHR, and perform optimization.

Operation 909: if the access node 3 judges that the SHR should be forwarded to the target cell, the access node 3 transmits a message 9 to the core network entity. The message includes at least one of:
the SHR.

The message 9 may be transmitted using an Ng interface or an S1 interface.

When the Ng interface is used, the message 1 may include, but is not limited to, at least one of: RAN CONFIGURATION UPDATE, UPLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE, eNB DIRECT INFORMATION TRANSFER, eNB CONFIGURATION TRANSFER, and a newly defined S1 message.

Operation 910: the core network entity transmits a message 10 to the access node 2, which includes the information received in the previous operation.

The message 10 may be transmitted using an Ng interface or an S1 interface.

When the Ng interface is used, the message 1 may include, but is not limited to, at least one of: RAN CONFIGURATION UPDATE ACKNOWLEDGE, AMF CONFIGURATION UPDATE, DOWNLINK RAN CONFIGURATION TRANSFER, and a newly defined Ng message.

When an inter-node interface is the S1 interface, a message of the inter-node interface includes, but is not limited to, at least one of: ENB CONFIGURATION UPDATE ACKNOWLEDGE, MME CONFIGURATION UPDATE, MME DIRECT INFORMATION TRANSFER, MME CONFIGURATION TRANSFER, and a newly defined S1 message.

The target cell may analyze and judge the problem according to content of the SHR, and perform optimization.

Through the above operations, the network may analyze the SHR, and judge whether self-optimization and self-configuration are needed according to the information in the SHR, such as optimization of the handover timing, optimization of selection of the target cell, optimization of handover-related parameters, so that the network performance and user experience are improved.

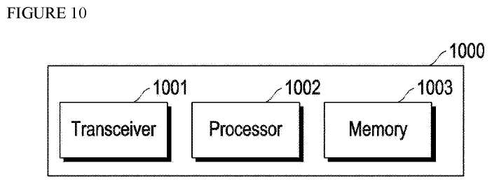

FIG. 10 illustrates a schematic block diagram of a device 1000 according to various embodiments of the disclosure, which may be configured to implement any one or more of the methods according to various embodiments of the disclosure. Therefore, it should be understood that the device 1000 may be, for example, the node 1, the node 2, the node 3, or the node 4 described in the disclosure, or a part thereof.

Referring to FIG. 10, the device 1000 includes a transceiver 1001, at least one processor 1002 and a memory 1003.

The transceiver 1001 is configured to receive and/or transmit signals.

The processor 1002 is operatively connected to the transceiver 1001 and the memory 1003. The processor 1002 may be implemented as one or more processors for operating according to any one or more of the methods described in various embodiments of the disclosure.

The memory 1003 is configured to store computer programs and data. The memory 1003 may include a non-transitory memory for storing operations and/or code instructions executable by the processor 1002. The memory 1003 may include non-transitory programs and/or instructions readable by the processor, which, when executed, cause the processor 1002 to implement the operations of any one or more of the methods according to various embodiments of the disclosure. The memory 1003 may further include a random access memory or buffer(s) to store intermediate processing data from various functions performed by the processor 1002.

Those of ordinary skill in the art will recognize that the description of the methods for configuration and reporting of the disclosure is only illustrative and is not intended to be limited in any way. Other embodiments will be readily apparent to those of ordinary skill in the art having the benefit of the disclosure.

For the sake of clarity, not all conventional features of the implementations of the methods and devices of the disclosure are shown and described. Of course, it should be understood that in the development of any such actual implementations of the methods and devices for configuration and reporting, in order to achieve the specific goals of the developers, such as conforming to the constraints related to applications, systems, networks and businesses, many implementation-specific decisions may need to be made, and these specific goals will vary with different implementations and developers.

The modules, processing operations and/or data structures described according to the disclosure may be implemented using various types of operating systems, computing platforms, network devices, computer programs and/or general-purpose machines. In addition, those skilled in the art will recognize that less general-purpose devices such as hard-wired devices, field programmable gate array (FPGA), application specific integrated circuits (ASIC), etc. may also be used. In the case that a method including a series of operations and sub-operations is implemented by a processor, computer or machine, and those operations and sub-operations may be stored as a series of non-transitory code instructions readable by the processor, computer or machine, they may be stored on a tangible and/or non-transitory medium.

The modules of the methods and devices for configuration and reporting described herein may include software, firmware, hardware or any combination(s) of software, firmware or hardware suitable for the purpose described herein.

In the methods for configuration and reporting described herein, various operations and sub-operations may be performed in various orders, and some of the operations and sub-operations may be optional.

Although the foregoing disclosure of the application has been made by non-limiting illustrative embodiments, these embodiments may be arbitrarily modified within the scope of the appended claims without departing from the spirit and nature of the disclosure.

1-15. (canceled)

16. A method performed by a source node in a wireless communication system, the method comprising:
transmitting, by the source node to a user equipment (UE), configuration information related to a successful handover report (SHR);
receiving, by the source node form the UE, the SHR based on the first configuration information;
transmitting, by the source node to a target node, a handover request message, comprising information related to a threshold value of a first timer, information related to a threshold value of a second timer;
receiving, by the source node from the target node, a handover request acknowledge message comprising the information related to the threshold value of the first timer, the information related to the threshold value of the second timer, and information related to a threshold value of a third timer; and
transmitting, by the source node to the UE, a radio resource control (RRC) reconfiguration message comprising the information related to the threshold value of the first timer, the information related to the threshold value of the second timer, and the information related to the threshold value of the third timer.

17. The method of claim 16, wherein the SHR comprises at least one of:
a cell identity of the source node;
a cell identity of the target node;
a measurement result of the source node;
a measurement result of the target node;
a measurement result of a neighboring cell;
information indicating that a radio link failure (RLF) occurs on the source node in a dual active protocol stack (DAPS) handover;
a difference between a time when the UE receives conditional handover (CHO) configuration-related information and a time when the UE performs the CHO;
location information of the UE; and
user plane (UP) measurements result-related information.

18. The method of claim 17, wherein the UP measurements result-related information includes a service interruption time.

19. A method performed by a user equipment (UE) in a wireless communication system, the method comprising:
receiving, by the UE form a source node, configuration information related to a successful handover report (SHR);
transmitting, by the UE to the source node, the SHR based on the configuration information; and
receiving, by the UE from the source node, a radio resource control (RRC) reconfiguration message comprising information related to a threshold value of a first timer, information related to a threshold value of a second timer, and information related to a threshold value of a third timer.

20. The method of claim 19, wherein the SHR comprises at least one of:
a cell identity of the source node;
a cell identity of the target node;
a measurement result of the source node;
a measurement result of the target node;
a measurement result of a neighboring cell;
information indicating that a radio link failure (RLF) occurs on the source node in a dual active protocol stack (DAPS) handover;
a difference between a time when the UE receives conditional handover (CHO) configuration-related information and a time when the UE performs the CHO;
location information of the UE; and
user plane (UP) measurements result-related information.

21. The method of claim 20, wherein the UP measurements result-related information includes a service interruption time.

22. The method of claim 19, further comprising:
storing the SHR based on the RRC reconfiguration message in case that:
the first timer is started and an elapsed time of the first timer is greater than the threshold value of the first timer; or
the second timer is started and an elapsed time of the second timer is greater than the threshold value of the second timer; or
the third timer is started and an elapsed time of the third timer is greater than the threshold value of the third timer.

23. A source node in a wireless communication system, the source node comprising:
a transceiver configured to receive and transmit signals;
a memory configured to store information and data;
at least one processor coupled with the memory and the transceiver, and configured to:
transmit, to a user equipment (UE), configuration information related to a successful handover report (SHR),
receive, form the UE, the SHR based on the first configuration information,
transmit, to a target node, a handover request message, comprising information related to a threshold value of a first timer, information related to a threshold value of a second timer,
receive, from the target node, a handover request acknowledge message comprising the information related to the threshold value of the first timer, the information related to the threshold value of the second timer, and information related to a threshold value of a third timer, and
transmit, to the UE, a radio resource control (RRC) reconfiguration message comprising the information related to the threshold value of the first timer, the information related to the threshold value of the second timer, and the information related to the threshold value of the third timer.

24. The source node of claim 23, wherein the SHR comprises at least one of:
a cell identity of the source node;
a cell identity of the target node;
a measurement result of the source node;
a measurement result of the target node;
a measurement result of a neighboring cell;
information indicating that a radio link failure (RLF) occurs on the source node in a dual active protocol stack (DAPS) handover;
a difference between a time when the UE receives conditional handover (CHO) configuration-related information and a time when the UE performs the CHO;
location information of the UE; and
user plane (UP) measurements result-related information.

25. The source node of claim 24, wherein the UP measurements result-related information includes a service interruption time.

26. A user equipment (UE) in a wireless communication system, the UE comprising:
a transceiver configured to receive and transmit signals;
a memory configured to store information and data;
at least one processor coupled with the memory and the transceiver, and configured to:
receive, form a source node, configuration information related to a successful handover report (SHR),
transmit, to the source node, the SHR based on the configuration information, and
receive, from the source node, a radio resource control (RRC) reconfiguration message comprising information related to a threshold value of a first timer, information related to a threshold value of a second timer, and information related to a threshold value of a third timer.

27. The UE of claim 26, wherein the SHR comprises at least one of:
a cell identity of the source node;
a cell identity of the target node;
a measurement result of the source node;
a measurement result of the target node;
a measurement result of a neighboring cell;
information indicating that a radio link failure (RLF) occurs on the source node in a dual active protocol stack (DAPS) handover;
a difference between a time when the UE receives conditional handover (CHO) configuration-related information and a time when the UE performs the CHO;
location information of the UE; and
user plane (UP) measurements result-related information.

28. The UE of claim 27, wherein the UP measurements result-related information includes a service interruption time.

29. The UE of claim 26, wherein the at least one processor is further configured to:
store the SHR based on the RRC reconfiguration message in case that:
the first timer is started and an elapsed time of the first timer is greater than the threshold value of the first timer; or
the second timer is started and an elapsed time of the second timer is greater than the threshold value of the second timer; or
the third timer is started and an elapsed time of the third timer is greater than the threshold value of the third timer.
